(19) United States
(12) Patent Application Publication
(10) Pub. No.: US 2024/0348270 A1
(43) Pub. Date: Oct. 17, 2024

(54) ELECTRONIC DEVICE IDENTIFYING CHARACTERISTICS OF SIGNAL TRANSMITTED THROUGH ANTENNA

(71) Applicant: Samsung Electronics Co., Ltd., Suwon-si (KR)

(72) Inventors: Yousung LEE, Suwon-si (KR); Hyoseok NA, Suwon-si (KR); Yohan MOON, Suwon-si (KR); Seonjun KIM, Suwon-si (KR); Dongil YANG, Suwon-si (KR)

(21) Appl. No.: 18/622,212

(22) Filed: Mar. 29, 2024

Related U.S. Application Data
(63) Continuation of application No. PCT/KR2024/002702, filed on Feb. 29, 2024.

(30) Foreign Application Priority Data
Apr. 13, 2023 (KR) 10-2023-0049046
May 11, 2023 (KR) 10-2023-0061387

(51) Int. Cl. H04B 1/00; H01Q 3/24; H04B 1/04

(52) U.S. Cl. CPC H04B 1/0078; H01Q 3/24; H04B 1/04; H04B 2001/0408

(57) ABSTRACT

An electronic device is provided. The electronic device includes a power amplifier (PA). The electronic device includes a first switch. The electronic device includes a second switch. The electronic device includes a plurality of antennas including a first antenna and a second antenna. The electronic device includes first circuitry coupled with the first antenna. The electronic device includes second circuitry capable of being coupled with the second antenna according to control of the second switch. The electronic device includes a radio frequency integrated circuit (RFIC). The electronic device includes at least one processor.

### CROSS-REFERENCE TO RELATED APPLICATIONS

This application is a continuation of International Application No. PCT/KR2024/002702 designating the United States, filed on Feb. 29, 2024, in the Korean Intellectual Property Receiving Office and claiming priority to Korean Patent Application Nos. 10-2023-0049046, filed on Apr. 13, 2023, and 10-2023-0061387, filed on May 11, 2023, in the Korean Intellectual Property Office, the disclosures of each of which are incorporated by reference herein in their entireties.

### BACKGROUND

### Field

The disclosure relates to an electronic device identifying characteristics of a signal transmitted through an antenna.

### Description of Related Art

An electronic device may transmit a signal through an antenna. The signal may be transmitted with a transmit (Tx) power obtained using a power amplifier (PA) related to the antenna. For example, the electronic device may obtain a coupling signal of the signal transmitted through the antenna. The coupling signal, for example, may indicate characteristics of the signal. For example, the electronic device may communicate with an external electronic device based on the characteristics of the signal indicated by the coupling signal.

The above-described information may be provided as a related art for the purpose of helping to understand the present disclosure. No claim or determination is raised as to whether any of the above-described information may be applied as a prior art related to the present disclosure.

### SUMMARY

An electronic device is provided. The electronic device may comprise a power amplifier (PA). The electronic device may comprise a first switch. The electronic device may comprise a second switch. The electronic device may comprise a plurality of antennas including a first antenna and a second antenna. The electronic device may comprise first circuitry coupled with the first antenna. The electronic device may comprise second circuitry capable of being coupled with the second antenna according to control of the second switch. The electronic device may comprise a radio frequency integrated circuit (RFIC). The electronic device may comprise at least one processor comprising processing circuitry. At least one processor may be configured to, while the PA is connected to the first circuitry among the first circuitry and the second circuitry in accordance with control of the first switch, obtain, through the RFIC from the first circuitry, a first coupling signal of a sounding reference signal (SRS) transmitted with a transmit (Tx) power obtained using the PA via the first antenna. At least one processor may be configured to, while the PA is connected to the second circuitry among the first circuitry and the second circuitry in accordance with control of the first switch, obtain, through the RFIC from the second circuitry coupled with the second antenna in accordance with control of the second switch, a second coupling signal of the SRS transmitted with the Tx power via the second antenna.

An electronic device is provided. The electronic device may comprise a power amplifier (PA). The electronic device may comprise a plurality of antennas including a first antenna and a second antenna. The electronic device may comprise a circuit coupled with the first antenna. The electronic device may comprise a first switch including a first terminal connectable to the PA, a second terminal, and a third terminal. The electronic device may comprise a second switch configured to connect the second antenna to the third terminal of the first switch. The electronic device may comprise a third switch including a first terminal connected to the second terminal of the first switch, a second terminal connected to the third terminal of the first switch and connected to the second switch, and a third terminal connected to the circuit. The electronic device may comprise a radio frequency integrated circuit (RFIC). The electronic device may comprise at least one processor comprising processing circuitry. At least one processor may be configured to obtain, based on controlling the first switch and the third switch to connect, to the first terminal of the first switch connected to the PA, the second terminal of the first switch among the second terminal of the first switch and the third terminal of the first switch and connect, to the third terminal of the third switch, the first terminal of the third switch among the first terminal of the third switch and the second terminal of the third switch, a first coupling signal of a sounding reference signal (SRS) transmitted with a transmit (Tx) power obtained using the PA via the first antenna. At least one processor may be configured to transmit, based on controlling the first switch to connect, to the first terminal of the first switch connected to the PA, the third terminal of the first switch among the second terminal of the first switch and the third terminal of the first switch, the SRS with Tx power via the second antenna. At least one processor may be configured to obtain, based on controlling the third switch to connect, to the third terminal of the third switch, the second terminal of the third switch from the first terminal of the third switch and the second terminal of the third switch, a second coupling signal of the SRS transmitted via the second antenna, from the circuit through the RFIC.

An electronic device is provided. The electronic device may comprise a power amplifier (PA). The electronic device may comprise a plurality of antennas including a first antenna, a second antenna, a third antenna, and a fourth antenna. The electronic device may comprise a circuit coupled with the first antenna. The electronic device may comprise a radio frequency integrated circuit (RFIC). The electronic device may comprise a first switch including a first terminal connectable to the PA, a second terminal connected to the circuit, and a third terminal. The electronic device may comprise a second switch including a first terminal connected to the third terminal of the first switch, a second terminal connected to the second antenna, a third terminal connected to the third antenna, a fourth terminal connected to the fourth antenna, and a fifth terminal disconnected from all of the plurality of antennas. The electronic device may comprise a third switch including a first terminal connected to the RFIC, a second terminal connected to the circuit, and a third terminal connected to the fifth terminal of the second switch. The electronic device may comprise at least one processor comprising processing circuitry. At least one processor may be configured to obtain a first coupling signal of a sounding reference signal (SRS) transmitted with a transmit (Tx) power obtained using the PA via the first antenna, through the RFIC from the circuit, based on controlling the first switch and the third switch to connect, to the second terminal of the first switch among the second terminal of the first switch and the third terminal of the first switch, the first terminal of the first switch connected to the PA and connect, to the second terminal of the third switch among the second terminal of the third switch and the third terminal of the third switch, the first terminal of the third switch. At least one processor may be configured to transmit the SRS with the Tx power via each of the second antenna, the third antenna, and the fourth antenna, based on controlling the first switch to connect the third terminal of the first switch among the second terminal of the first switch and the third terminal of the first switch to the first terminal of the first switch connected to the PA. At least one processor may be configured to obtain each of a second coupling signal, a third coupling signal, a fourth coupling signal of the SRS transmitted via each of the second antenna, the third antenna, and the fourth antenna, through the RFIC from the circuit, based on controlling the third switch to connect the third terminal of the third switch among the second terminal of the third switch and the third terminal of the third switch to the first terminal of the third switch.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 illustrates an electronic device including a circuit coupled with a portion of a plurality of antennas.

FIG. 2 illustrates an exemplary electronic device that includes first circuitry coupled with an antenna and second circuitry capable of being coupled to one or more antennas different the antenna.

FIG. 3 illustrates an example of one or more components related to one or more antennas.

FIGS. 4 and 5 illustrate an example of second circuitry.

FIGS. 6, 7, 8, and 9 illustrate an exemplary electronic device including a circuit that is coupled with an antenna and identifies characteristics of a signal transmitted via one or more antennas different from the antenna.

FIG. 10 illustrates, in order to identify a characteristic of a signal transmitted through one or more antennas, an exemplary electronic device including a switch connected to a circuit coupled with an antenna different from the one or more antennas.

FIG. 11 illustrates, in order to identify a characteristic of a signal transmitted through one or more antennas, an exemplary electronic device including a switch that includes one or more terminals respectively connected to one or more antennas and a terminal disconnected from the one or more antennas.

FIG. 12 is a block diagram of an electronic device in a network environment, according to various embodiments.

### DETAILED DESCRIPTION

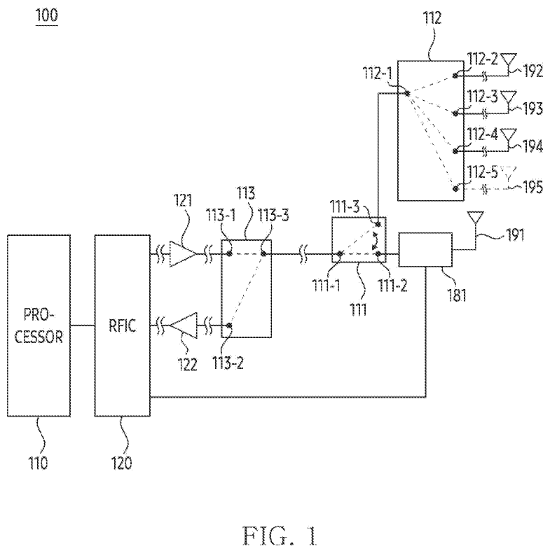

FIG. 1 illustrates an electronic device including a circuit coupled with a portion of a plurality of antennas.

Referring to FIG. 1, an electronic device 100 may include a processor (e.g., including processing circuitry) 110, a radio frequency integrated circuit (RFIC) 120, a power amplifier (PA) 121, a low noise amplifier (LNA) 122, a switch 111, a switch 112, a switch 113, a circuit 181, and a plurality of antennas. For example, the processor 110 may include, without limitation, a communication processor (CP) and/or an application processor (AP). For example, the RFIC 120 may be referred to as a transceiver. For example, the plurality of antennas may include a first antenna 191, a second antenna 192, a third antenna 193, and a fourth antenna 194. For example, the plurality of antennas may further include a fifth antenna 195.

For example, each of the plurality of antennas may receive a signal from an external electronic device. For example, the signal received through the first antenna 191 may be provided to the RFIC 120 through the switch 111 and the switch 113. For example, in order to provide the signal to the RFIC 120, the processor 110 may control the switch 111 to connect a first terminal 111-1 to a second terminal 111-2 from among the second terminal 111-2 and a third terminal 111-3, and control the switch 113 to connect a third terminal 113-3 to a second terminal 113-2 from among a first terminal 113-1 and the second terminal 113-2.

For example, the RFIC 120 may include a receiving circuit including one or more receive (Rx) chains for the signal received through at least a portion of the plurality of antennas. For example, the signal received through the first antenna 191 may be provided to the receiving circuit through the LNA 122. For example, the receiving circuit may include a mixer for downward conversion, an analog to digital converter (ADC), and/or a PA (e.g., another PA distinct from the LNA 122). For example, the signal received through each of the second antenna 192 to the fourth antenna 194 (or the second antenna 192 to the fifth antenna 195) may be provided to the receiving circuit through another LNA (not shown in FIG. 1) distinct from the LNA 122.

For example, a signal received through at least a portion of the plurality of antennas may be processed within the RFIC 120 or may be processed using the receiving circuit. For example, the processed signal may be provided to the processor 110.

For example, the processor 110 may include various processing circuitry. For example, as used herein, including the claims, the term “processor” may include various processing circuitry, including at least one processor, wherein one or more of at least one processor may be configured to perform various functions described herein. Additionally, the at least one processor may include a combination of processors performing various of the recited/disclosed functions. At least one processor may execute program instructions to achieve or perform various functions. At least one processor 110 may execute a function corresponding to the signal, by processing the signal obtained from the RFIC 120.

For example, the processor 110 may generate or obtain a signal to be transmitted through at least a portion of the plurality of antennas. For example, the signal may be provided from the processor 110 to the RFIC 120.

For example, the processor 110 may control the switch 111, the switch 112, and/or the switch 113 for the transmission of the signal.

For example, in order to transmit the signal through the first antenna 191, the processor 110 may control the switch 113 to connect the third terminal 113-3 to the first terminal 113-1 from among the first terminal 113-1 and the second terminal 113-2. For example, in order to transmit the signal through the first antenna 191, the processor 110 may control the switch 111 to connect the first terminal 111-1 to the second terminal 111-2 from among the second terminal 111-2 and the third terminal 111-3.

For example, in order to transmit the signal through the second antenna 192, the processor 110 may control the switch 113 to connect the third terminal 113-3 to the first terminal 113-1 from among the first terminal 113-1 and the second terminal 113-2. For example, in order to transmit the signal through the second antenna 192, the processor 110 may control the switch 111 to connect the first terminal 111-1 to the third terminal 111-3 from among the second terminal 111-2 and the third terminal 111-3. For example, in order to transmit the signal through the second antenna 192, the processor 110 may control the switch 112 to connect the first terminal 112-1 to a second terminal 112-2 from among the second terminal 112-2, a third terminal 112-3, a fourth terminal 112-4, and a fifth terminal 112-5.

For example, in order to transmit the signal through the third antenna 193, the processor 110 may control the switch 113 to connect the third terminal 113-3 to the first terminal 113-1 from among the first terminal 113-1 and the second terminal 113-2. For example, in order to transmit the signal through the third antenna 193, the processor 110 may control the switch 111 to connect the first terminal 111-1 to the third terminal 111-3 from among the second terminal 111-2 and the third terminal 111-3. For example, in order to transmit the signal through the third antenna 193, the processor 110 may control the switch 112 to connect the first terminal 112-1 to the third terminal 112-3 from among the second terminal 112-2, the third terminal 112-3, the fourth terminal 112-4, and the fifth terminal 112-5.

For example, in order to transmit the signal through the fourth antenna 194, the processor 110 may control the switch 113 to connect the third terminal 113-3 to the first terminal 113-1 from among the first terminal 113-1 and the second terminal 113-2. For example, in order to transmit the signal through the fourth antenna 194, the processor 110 may control the switch 111 to connect the first terminal 111-1 to the third terminal 111-3 from among the second terminal 111-2 and the third terminal 111-3. For example, in order to transmit the signal through the fourth antenna 194, the processor 110 may control the switch 112 to connect the first terminal 112-1 to the fourth terminal 112-4 from among the second terminal 112-2, the third terminal 112-3, the fourth terminal 112-4, and the fifth terminal 112-5.

For example, when the fifth antenna 195 is included in the plurality of antennas, the processor 110 may control the switch 113 to connect the third terminal 113-3 to the first terminal 113-1 from among the first terminal 113-1 and the second terminal 113-2 in order to transmit the signal through the fifth antenna 195. For example, in order to transmit the signal through the fifth antenna 195, the processor 110 may control the switch 111 to connect the first terminal 111-1 to the third terminal 111-3 from among the second terminal 111-2 and the third terminal 111-3. For example, in order to transmit the signal through the fifth antenna 195, the processor 110 may control the switch 112 to connect the first terminal 112-1 to the fifth terminal 112-5 from among the second terminal 112-2, the third terminal 112-3, the fourth terminal 112-4, and the fifth terminal 112-5.

For example, the RFIC 120 may include a transmitting circuit including one or more transmit (Tx) chains for the signal to be transmitted through at least a portion of the plurality of antennas. Although not illustrated in FIG. 1, the transmitting circuit may be connected to the PA 121. For example, connecting of the transmitting circuit with the PA 121 may indicate that the transmitting circuit is directly connected to the PA 121. For example, connecting of the transmitting circuit with the PA 121 may indicate that the transmitting circuit is connected to the PA 121 through another component (e.g., indirectly connected). For example, the transmitting circuit may include a mixer for upward conversion, a digital to analog converter (DAC), and/or a PA (e.g., another PA distinct from the PA 121). For example, the signal provided by the processor 110 may be processed within the RFIC 120 or may be processed using the transmitting circuit. For example, the processed signal may be provided to the PA 121.

For example, the PA 121 may be used to obtain or set a Tx power of the signal (e.g., the signal processed within the RFIC 120) to be transmitted through an antenna (e.g., at least a portion of the plurality of antennas). For example, the signal may be transmitted through the first antenna 191 with the Tx power. For example, the signal may be transmitted through the second antenna 192 with the Tx power. For example, the signal may be transmitted through the third antenna 193 with the Tx power. For example, the signal may be transmitted through the fourth antenna 194 with the Tx power. For example, the signal may be transmitted through the fifth antenna 195 with the Tx power. As a non-limiting example, a power of the signal output from each of the first antenna 191 to the fifth antenna 195 may be different from the Tx power. For example, the power may vary according to a state of paths from the PA 121 to each of the first antenna 191 to the fifth antenna 195.

For example, the circuit 181 may be coupled with the first antenna 191 among the plurality of antennas. For example, the circuit 181 may be referred to as a coupler. For example, the circuit 181 may be used to obtain a coupling signal of the signal transmitted with the Tx power through the first antenna 191. For example, the coupling signal may be provided to the RFIC 120.

For example, the RFIC 120 may include a receiving circuit including one or more receive (Rx) chains for the coupling signal. For example, the receiving circuit may include a mixer for downward conversion, an analog to digital converter (ADC), and/or a PA. For example, the coupling signal processed within the RFIC 120 or processed using the receiving circuit may be provided to the processor 110.

For example, the processor 110 may identify a characteristic (or attribute) of the signal transmitted through the first antenna 191 based on the coupling signal. As a non-limiting example, the processor 110 may identify a difference between the power of the signal output from the first antenna 191 and the Tx power obtained using the PA 121, based on the coupling signal. For example, the processor 110 may identify a state related to the first antenna 191 used for transmission of the signal, based on the coupling signal. As a non-limiting example, the processor 110 may identify whether the first antenna 191 is covered (or in contact with an external object) by the external object (e.g., user's hand, and the like) based on the coupling signal.

For example, the circuit 181 may be coupled with the first antenna 191 from among the plurality of antennas, and may be disconnected from remaining antennas except for the first antenna 191 from among the plurality of antennas (e.g., the second antenna 192 to the fourth antenna 194 (or the second antenna 192 to the fifth antenna 195). For example, each of the remaining antennas may be disconnected from the circuit 181, and may not be coupled with a circuit for identifying a characteristic (and/or a state related to each of the remaining antennas) of a signal transmitted through each of the remaining antennas, such as the circuit 181. For example, unlike the first antenna 191, each of the remaining antennas may be mainly used for receiving a signal from an external electronic device. For example, each of the remaining antennas may be used for transmitting a sounding reference signal (SRS), but a main function of each of the remaining antennas may be reception. For example, since a main function of each of the remaining antennas is reception, the electronic device 100 may not include the circuit, which is coupled with each of the remaining antennas, such as the circuit 181 coupled with the first antenna 191. For example, the electronic device 100 may not include the circuit coupled with each of the remaining antennas, in order to enhance portability of the electronic device 100 (or miniaturize the electronic device 100). For example, since the electronic device 100 does not include the circuit, the processor 110 may not obtain a coupling signal of a signal transmitted through the second antenna 192, a coupling signal of a signal transmitted through the third antenna 193, and a coupling signal of a signal transmitted through the fourth antenna 194, via the RFIC 120. For example, when the electronic device 100 includes the fifth antenna 195, the processor 110 may not obtain a coupling signal of a signal transmitted through the fifth antenna 195 via the RFIC 120.

For example, since the processor 110 does not obtain a coupling signal of a signal transmitted through the second antenna 192, a coupling signal of a signal transmitted through the third antenna 193, and a coupling signal of a signal transmitted through the fourth antenna 194 via the RFIC 120, another signal, which is transmitted using the PA 121 through the first antenna 191 after a signal (e.g., a sounding reference signal (SRS)) is transmitted with the Tx power obtained using the PA 121 through each of the first antenna 191 to fourth antennas 194 may be degraded. For example, throughput of the other signal, which is transmitted through the first antenna 191 using the PA 121 after the signal is transmitted through each of the first antennas 191 to the fourth antennas 194, may be reduced. For example, a Tx power of the other signal, which is transmitted through the first antenna 191 using the PA 121 after the signal is transmitted through each of the first antennas 191 to the fourth antennas 194, may be smaller than a targeted Tx power. For example, reduction in the throughput of the other signal may be indicated as shown in Table 1.

TABLE 1

| Number | Throughput of other | Throughput of other |
|---|---|---|
| of TEST | Signal in Case 1 | Signal in Case 2 |
| 1 | 29.8 | 13.2 |
| 2 | 28.1 | 14.2 |
| 3 | 32.8 | 27.1 |
| 4 | 28 | 13.6 |
| 5 | 32.4 | 25 |

In Table 1, the throughput of the other signal in Case 1 indicates throughput of the other signal transmitted through the first antenna 191 based on a coupling signal of the signal transmitted through each of the second antenna 192 to the fourth antenna 194, and the throughput of the other signal in Case 2 indicates throughput of the other signal transmitted through the first antenna 191 without use of the coupling signal of the signal transmitted through each of the first antennas 191 to the fourth antennas 194 as shown in FIG. 1. For example, Table 1 may indicate that the throughput of the other signal in Case 2 is reduced by about 38% on average compared to the throughput of the other signal in Case 1.

Unlike the electronic device 100, an electronic device to be illustrated below may include components for identifying a characteristic (or a state of each of the second antenna 192 to the fourth antenna 194 (or the second antenna 192 to the fifth antenna 195)) used for transmission of the above signals) of the signal transmitted through the remaining antennas (e.g., the second antenna 192 to the fourth antenna 194 (or the second antenna 192 to the fifth antenna 195)) for the throughput of the other signal.

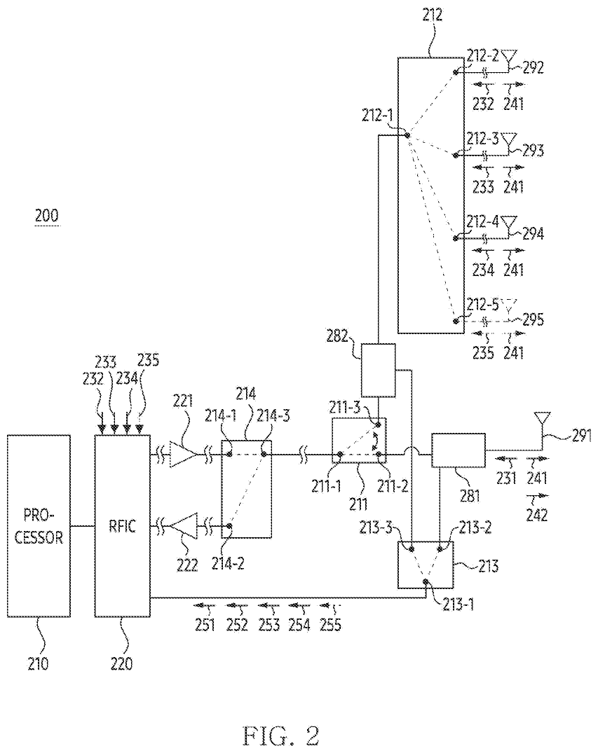

For example, unlike the electronic device 100, the electronic device may include a circuit capable of being coupled with the second antenna 192 to the fourth antenna 194 (or the second antenna 192 to the fifth antenna 195). The electronic device including the circuit may be illustrated within the description of FIG. 2.

FIG. 2 illustrates an exemplary electronic device that includes first circuitry coupled with an antenna and second circuitry capable of being coupled to one or more antennas different the antenna.

Referring to FIG. 2, the electronic device 200 may include a processor (e.g., including processing circuitry) 210, an RFIC 220, a PA 221, an LNA 222, a switch 211, a switch 212, a switch 213, a switch 214, first circuitry 281, second circuitry 282, and a plurality of antennas.

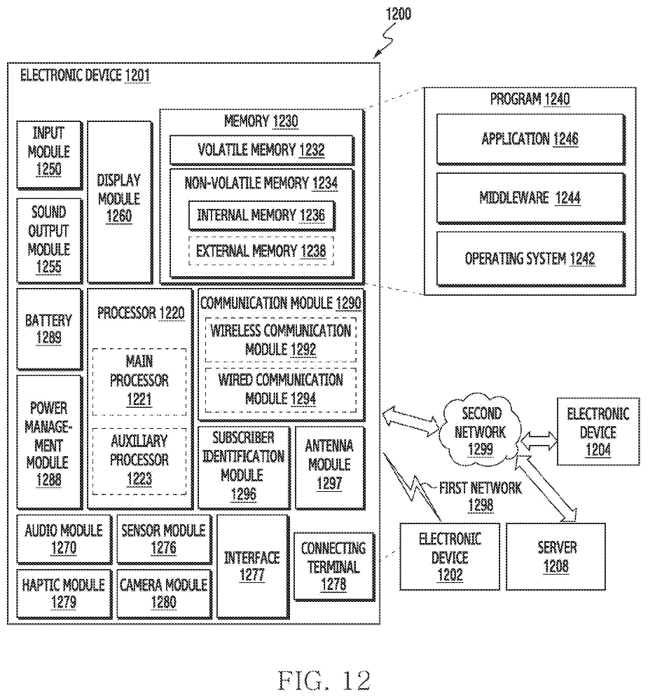

For example, the processor 210 may include various processing circuitry. For example, as used herein, including the claims, the term “processor” may include various processing circuitry, including at least one processor, wherein one or more of at least one processor may be configured to perform various functions described herein. Additionally, the at least one processor may include a combination of processors performing various of the recited/disclosed functions. At least one processor may execute program instructions to achieve or perform various functions. The processor 210 may include at least a portion of a processor 1220 of FIG. 12, or may at least partially correspond to the processor 1220 of FIG. 12. For example, the processor 210 may include an AP and/or a CP.

For example, the RFIC 220 may include at least a portion of a wireless communication module 1292 of FIG. 12 and/or at least a portion of an antenna module 1297 of FIG. 12, or at least partially correspond to the wireless communication module 1292 of FIG. 12 and/or the antenna module 1297. For example, the RFIC 220 may be referred to as a transceiver.

For example, the plurality of antennas may include a first antenna 291 to a fourth antenna 294. For example, the plurality of antennas may further include a fifth antenna 295. For example, the plurality of antennas may include at least a portion of the antenna module 1297 of FIG. 12 or at least partially correspond to the antenna module 1297 of FIG. 12.

For example, the PA 221, the LNA 222, the switch 211, the switch 212, the switch 213, the switch 214, the first circuitry 281, and/or the second circuitry 282 may be included in at least a portion of the wireless communication module 1292 of FIG. 12 and/or at least a portion of the antenna module 1297 of FIG. 12, or may at least partially correspond to the wireless communication module 1292 of FIG. 12 and/or the antenna module 1297 of FIG. 12. Although not illustrated in FIG. 2, the PA 221, the LNA 222, the switch 211, the switch 212, the switch 213, the switch 214, the first circuitry 281, and/or the second circuitry 282 may be included in one or more radio frequency front ends (RFFEs) of the electronic device 200.

For example, each of the plurality of antennas may receive a signal from an external electronic device. For example, a signal 231 received through the first antenna 291 may be provided to the RFIC 220 through the switch 211 and the switch 214. For example, in order to provide the signal 231 to the RFIC 220, the processor 210 may control the switch 211 to connect a first terminal 211-1 to a second terminal 211-2 from among the second terminal 211-2 and a third terminal 211-3, and control the switch 214 to connect a third terminal 214-3 to a second terminal 214-2 from among a first terminal 214-1 and the second terminal 214-2. For example, the switch 214 may be used to support a time division duplex (TDD). For example, the signal 231 may be provided to the RFIC 220, through the LNA 222, from the switch 214 controlled to connect the third terminal 214-3 to the second terminal 214-2.

For example, the RFIC 220 may include a receiving circuit including one or more receiving (RX) chains for a signal received through at least a portion of the plurality of antennas.

For example, the signal 231 received through the first antenna 291 may be provided to the receiving circuit through the LNA 222. Although not illustrated in FIG. 2, the receiving circuit may be connected to the LNA 222. For example, connecting of the receiving circuit with the LNA 222 may indicate that the receiving circuit is directly connected to the LNA 222. For example, connecting of the receiving circuit with the LNA 222 may indicate that the receiving circuit is connected to the LNA 222 through another component (e.g., indirectly connected). For example, the receiving circuit may include a mixer for downward conversion, an analog to digital converter (ADC), and/or a PA (e.g., another PA distinct from the LNA 222).

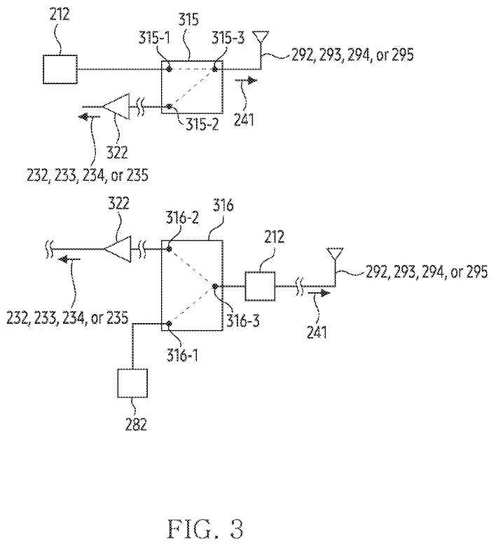

For example, each of a signal 232, a signal 233, and a signal 234 (or the signal 232, the signal 233, the signal 234, and a signal 235) received through each of the second antenna 292 to the fourth antenna 294 (or the second antenna 292 to the fifth antenna 295) may be provided to the receiving circuit. For example, each of the signal 232, the signal 233, and the signal 234 (or the signal 232, the signal 233, the signal 234, and the signal 235) may be provided to the receiving circuit through another LNA distinct from the LNA 222. For example, the other LNA may be illustrated within the description of FIG. 3.

FIG. 3 illustrates an example of one or more components related to one or more antennas.

Referring to FIG. 3, an electronic device 200 may further include a switch 315. For example, the switch 315 may include a first terminal 315-1 connected to a switch 212, a second terminal 315-2 connected to another LNA 322, and a third terminal 315-3. For example, the third terminal 315-3 may be connected to a second antenna 292, a third antenna 293, or a fourth antenna 294 (or the second antenna 292, the third antenna 293, the fourth antenna 294, or a fifth antenna 295). For example, each of a signal 232, a signal 233, and a signal 234 (or the signal 232, the signal 233, the signal 234, and a signal 235) may be provided to the RFIC 220 through another LNA 322, based on controlling the switch 315-3 to connect the third terminal 315-3 to the second terminal 315-2 from among the first terminal 315-1 and the second terminal 315-2.

For example, the electronic device 200 may further include a switch 316 instead of the switch 315 (or replacing the switch 315). For example, the switch 316 may include a first terminal 316-1 connected to second circuitry 282, a second terminal 316-2 connected to another LNA 322, and a third terminal 316-3 connected to the switch 212. For example, each of the signal 232, the signal 233, and the signal 234 (or the signal 232, the signal 233, the signal 234, and the signal 235) may be provided to the RFIC 220 through the other LNA 322, based on controlling the switch 316 to connect the third terminal 316-3 to the second terminal 316-2 from among the first terminal 316-1 and the second terminal 316-2.

Referring back to FIG. 2, a signal (e.g., the signal 231, the signal 232, the signal 233, the signal 234, and/or the signal 235) received through at least a portion of the plurality of antennas may be processed within the RFIC 220 or may be processed using the receiving circuit. For example, the processed signal may be provided to the processor 210.

For example, the processor 210 may execute a function corresponding to the signal, by processing the signal obtained from the RFIC 220.

For example, the processor 210 may generate or obtain a signal to be transmitted through at least a portion of the plurality of antennas. For example, the signal may be provided from the processor 210 to the RFIC 220. For example, the signal may include an SRS 241. For example, the signal may include a signal 242 that is distinct from the SRS 241 and includes control information and/or user data. For example, unlike the SRS 241, the signal 242 may be transmitted through a first antenna 291 from among the plurality of antennas. For example, the SRS 241 and/or the signal 242 may be provided from the processor 210 to the RFIC 220.

For example, the RFIC 220 may include a transmitting circuit including one or more transmit (Tx) chains for a signal (e.g., the SRS 241 and/or the signal 242) to be transmitted through at least a portion of the plurality of antennas. Although not illustrated in FIG. 2, the transmitting circuit may be connected to a PA 221. For example, connecting of the transmitting circuit with the PA 221 may indicate that the transmitting circuit is directly connected to the PA 221. For instance, connecting of the transmitting circuit with the PA 221 may indicate that the transmitting circuit is connected to the PA 221 through another component (e.g., indirectly connected). For example, the transmitting circuit may include a mixer for upward conversion, a digital to analog converter (DAC), and/or a PA (e.g., another PA distinct from the PA 221). For example, the signal provided by the processor 210 may be processed within the RFIC 220 or may be processed using the transmitting circuit. For example, the processed signal may be provided to the PA 221.

For example, the PA 221 may be used to obtain or set a Tx power of the signal (e.g., the signal processed within the RFIC 220) to be transmitted through an antenna (e.g., at least a portion of the plurality of antennas). For example, the signal (e.g., the SRS 241 and the signal 242) may be transmitted through the first antenna 291 with the Tx power. For example, the signal (e.g., the SRS 241) may be transmitted through the second antenna 292 with the Tx power. For example, the signal (e.g., the SRS 241) may be transmitted through the third antenna 293 with the Tx power. For example, the signal (e.g., the SRS 241) may be transmitted through the fourth antenna 294 with the Tx power. For example, the signal (e.g., the SRS 241) may be transmitted through the fifth antenna 295 with the Tx power. As a non-limiting example, a power of the signal output from each of the first antenna 191 to the fifth antenna 195 may be different from the Tx power. For example, the power may vary according to a state of paths from the PA 221 to each of the first antenna 291 to the fifth antenna 295.

For example, the processor 210 may control a switch 211, a switch 212, a switch 213, and/or a switch 214 for the transmission of the SRS 241.

For example, the processor 210 may control the switch 214 to connect a third terminal 214-3 to a first terminal 214-1 from among the first terminal 214-1 and a second terminal 214-2, for the SRS 241 transmitted through the first antenna 291. For example, the processor 210 may control the switch 211 to connect a first terminal 211-1 to a second terminal 211-2 from among the second terminal 211-2 and a third terminal 211-3, for the SRS 241 transmitted through the first antenna 291. For example, the PA 221 may be connected to first circuitry 281 from among the first circuitry 281 and second circuitry 282 according to the control of the switch 211. For example, the processor 210 may transmit the SRS 241 through the first antenna 291 with a Tx power obtained using the PA 221 connected to the first circuitry 281 in accordance with the control of the switch 211.

For example, the processor 210 may control the switch 214 to connect the third terminal 214-3 to the first terminal 214-1 from among the first terminal 214-1 and the second terminal 214-2, for the SRS 241 transmitted through the second antenna 292. For example, the processor 210 may control the switch 211 to connect the first terminal 211-1 to the third terminal 211-3 from among the second terminal 211-2 and the third terminal 211-3, for the SRS 241 transmitted through the second antenna 292. For example, the PA 221 may be connected to the second circuitry 282 from among the first circuitry 281 and the second circuitry 282 in accordance with control of the switch 211. For example, the processor 210 may control the switch 212 to connect the first terminal 212-1 to the second terminal 212-2 from among the second terminal 212-2 to a fifth terminal 212-5. For example, the processor 210 may transmit the SRS 241 through the second antenna 292 connected to the second circuitry 282 in accordance with control of the switch 212, with a Tx power obtained using the PA 221 connected to the second circuitry 282 in accordance with control of the switch 211. For example, referring to FIG. 3, when the electronic device 200 includes the switch 315, the second antenna 292 may be connected to the second circuitry 282 through the switch 315 and the switch 212 that form a connection between the first terminal 315-1 and the third terminal 315-3 in accordance with control of the processor 210. For example, when the electronic device 200 includes the switch 316, the second antenna 292 may be connected to the second circuitry 282 through the switch 316 and the switch 212 that form a connection between the first terminal 316-1 and the third terminal 316-3 in accordance with control of the processor 210.

Referring back to FIG. 2, the processor 210 may control the switch 214 to connect the third terminal 214-3 to the first terminal 214-1 from among the first terminal 214-1 and the second terminal 214-2, for the SRS 241 transmitted through the third antenna 293. For example, the processor 210 may control the switch 211 to connect the first terminal 211-1 to the third terminal 211-3 from among the second terminal 211-2 and the third terminal 211-3, for the SRS 241 transmitted through the third antenna 293. For example, the PA 221 may be connected to the second circuitry 282 from among the first circuitry 281 and the second circuitry 282 in accordance with the control of the switch 211. For example, the processor 210 may control the switch 212 to connect the first terminal 212-1 to the third terminal 212-3 from among the second terminal 212-2 to the fifth terminal 212-5. For example, the processor 210 may transmit the SRS 241 through the third antenna 293 connected to the second circuitry 282 in accordance with the control of the switch 212, with a Tx power obtained using the PA 221 connected to the second circuitry 282 in accordance with the control of the switch 211. For example, referring to FIG. 3, when the electronic device 200 includes the switch 315, the third antenna 293 may be connected to the second circuitry 282 through the switch 315 and the switch 212 that form a connection between the first terminal 315-1 and the third terminal 315-3 in accordance with control of the processor 210. For example, when the electronic device 200 includes the switch 316, the third antenna 293 may be connected to the second circuitry 282 through the switch 316 and the switch 212 that form a connection between the first terminal 316-1 and the third terminal 316-3 in accordance with the control of the processor 210.

Referring back to FIG. 2, the processor 210 may control the switch 214 to connect the third terminal 214-3 to the first terminal 214-1 from among the first terminal 214-1 and the second terminal 214-2, for the SRS 241 transmitted through the fourth antenna 294. For example, the processor 210 may control the switch 211 to connect the first terminal 211-1 to the third terminal 211-3 from among the second terminal 211-2 and the third terminal 211-3, for the SRS 241 transmitted through the fourth antenna 294. For example, the PA 221 may be connected to the second circuitry 282 from among the first circuitry 281 and the second circuitry 282 in accordance with the control of the switch 211. For example, the processor 210 may control the switch 212 to connect the first terminal 212-1 to a fourth terminal 212-4 from among the second terminal 212-2 to the fifth terminal 212-5. For example, the processor 210 may transmit the SRS 241 through the fourth antenna 294 connected to the second circuitry 282 in accordance with the control of the switch 212, with a Tx power obtained using the PA 221 connected to the second circuitry 282 in accordance with the control of the switch 211. For example, referring to FIG. 3, when the electronic device 200 includes the switch 315, the fourth antenna 294 may be connected to the second circuitry 282 through the switch 315 and the switch 212 that form a connection between the first terminal 315-1 and the third terminal 315-3 in accordance with control of the processor 210. For example, when the electronic device 200 includes the switch 316, the fourth antenna 294 may be connected to the second circuitry 282 through the switch 316 and the switch 212 that form a connection between the first terminal 316-1 and the third terminal 316-3 in accordance with control of the processor 210.

As a non-limiting example, transmission timing of the SRS 241 transmitted through the first antenna 291, transmission timing of the SRS 241 transmitted through the second antenna 292, transmission timing of the SRS 241 transmitted through the third antenna 293, and transmission timing of the SRS 241 transmitted through the fourth antenna 294 may be different from each other. As a non-limiting example, a bit sequence of the SRS 241 transmitted through the first antenna 291, a bit sequence of the SRS 241 transmitted through the second antenna 292, a bit sequence of the SRS 241 transmitted through the third antenna 293, and a bit sequence of the SRS 241 transmitted through the fourth antenna 294 may be different from each other.

Referring back to FIG. 2, when the electronic device 200 includes the fifth antenna 295, the processor 210 may control the switch 214 to connect the third terminal 214-3 to the first terminal 214-1 from among the first terminal 214-1 and the second terminal 214-2, for the SRS 241 transmitted through the fifth antenna 295. For example, the processor 210 may control the switch 211 to connect the first terminal 211-1 to the third terminal 211-3 from among the second terminal 211-2 and the third terminal 211-3, for the SRS 241 transmitted through the fifth antenna 295. For example, the PA 221 may be connected to the second circuitry 282 from among the first circuitry 281 and the second circuitry 282 in accordance with the control of the switch 211. For example, the processor 210 may control the switch 212 to connect the first terminal 212-1 to the fifth terminal 212-5 from among the second terminal 212-2 to the fifth terminal 212-5. For example, the processor 210 may transmit the SRS 241 through the fifth antenna 295 connected to the second circuitry 282 according to the control of the switch 212, with a Tx power obtained using the PA 221 connected to the second circuitry 282 according to the control of the switch 211. For example, referring to FIG. 3, when the electronic device 200 includes the switch 315, the fifth antenna 295 may be connected to the second circuitry 282 through the switch 315 and the switch 212 that form a connection between the first terminal 315-1 and the third terminal 315-3 in accordance with control of the processor 210. For example, when the electronic device 200 includes a switch 316, the fifth antenna 295 may be connected to the second circuitry 282 through the switch 316 and the switch 212 that form a connection between the first terminal 316-1 and the third terminal 316-3 in accordance with control of the processor 210.

For example, the first circuitry 281 may be coupled with the first antenna 291, and the second circuitry 282 may be coupled with one of the second antenna 292 to the fourth antenna 294 (or the second antenna 292 to the fifth antenna 295). For example, the first circuitry 281 may be referred to as a first coupler, and the second circuitry 282 may be referred to as a second coupler.

For example, unlike the first circuitry 281, an antenna coupled with the second circuitry 282 may be changed from among the second antenna 292 to the fourth antenna 294 (or the second antenna 292 to the fifth antenna 295) in accordance with control of the switch 212. For example, the processor 210 may control the switch 212 to connect the first terminal 212-1 to the second terminal 212-2 from among the second terminal 212-2 to the fifth terminal 212-5, for coupling between the second circuitry 282 and the second antenna 292. For example, the processor 210 may control the switch 212 to connect the first terminal 212-1 to the third terminal 212-3 from among the second terminal 212-2 to the fifth terminal 212-5, for coupling between the second circuitry 282 and the third antenna 293. For example, the processor 210 may control the switch 212 to connect the first terminal 212-1 to the fourth terminal 212-4 from among the second terminal 212-2 to the fifth terminal 212-5, for coupling between the second circuitry 282 and the fourth antenna 294. For example, the processor 210 may control the switch 212 to connect the first terminal 212-1 to the fifth terminal 212-5 from among the second terminal 212-2 to the fifth terminal 212-5, for coupling between the second circuitry 282 and the fifth antenna 295.

For example, the first circuitry 281 may be used to obtain a first coupling signal 251 of the SRS 241 transmitted through the first antenna 291. For example, the second circuitry 282 may be used to obtain each of a second coupling signal 252 to a fourth coupling signal 254 (or the second coupling signal 252 to a fifth coupling signal 255) of the SRS 241 transmitted through each of the second antenna 292 to the fourth antenna 294 (or the second antenna 292 to the fifth antenna 295).

For example, the first coupling signal 251 to the fourth coupling signal 254 (or the first coupling signal 251 to the fifth coupling signal 255) may be provided to the RFIC 220.

For example, the processor 210 may control the switch 213 to provide the first coupling signal 251 to the fourth coupling signal 254 (or the first coupling signal 251 to the fifth coupling signal 255) to the RFIC 220. For example, the processor 210 may control the switch 213 to connect the first terminal 213-1 to the second terminal 213-2 from among the second terminal 213-2 and the third terminal 213-3, in order to provide the first coupling signal 251 to the RFIC 220. For example, the processor 210 may control the switch 213 to connect the first terminal 213-1 to the third terminal 213-3 from among the second terminal 213-2 and the third terminal 213-3, in order to provide the second coupling signal 252 to the RFIC 220. For example, the processor 210 may control the switch 213 to connect the first terminal 213-1 to the third terminal 213-3 from among the second terminal 213-2 and the third terminal 213-3, in order to provide a third coupling signal 253 to the RFIC 220. For example, the processor 210 may control the switch 213 to connect the first terminal 213-1 to the third terminal 213-3 from among the second terminal 213-2 and the third terminal 213-3, in order to provide the fourth coupling signal 254 to the RFIC 220. For example, the processor 210 may control the switch 213 to connect the first terminal 213-1 to the third terminal 213-3 from among the second terminal 213-2 and the third terminal 213-3, in order to provide the fifth coupling signal 255 to the RFIC 220.

For example, the RFIC 220 may include a receiving circuit that includes one or more Rx chains for the first coupling signal 251 to the fourth coupling signal 254 (or the first coupling signal 251 to the fifth coupling signal 255). For example, the receiving circuit may include a mixer for downward conversion, an analog to digital converter (ADC), and/or a PA. For example, the first coupling signal 251 to the fourth coupling signal 254 (or the first coupling signal 251 to the fifth coupling signal 255), which is processed within the RFIC 220 or is processed using the receiving circuit, may be provided to the processor 210.

For example, the processor 210 may identify a characteristic (or attribute) of the SRS 241, based on at least a portion of the first coupling signal 251 to the fourth coupling signal 254 (or the first coupling signal 251 to the fifth coupling signal 255). As a non-limiting example, the processor 210 may identify a difference between a power of the SRS 241 output from the electronic device 200 and a Tx power obtained using the PA 221, based on the at least portion of the first coupling signal 251 to the fourth coupling signal 254 (or the first coupling signal 251 to the fifth coupling signal 255). For example, the processor 210 may identify a state related to the first antenna 291, based on the at least a portion of the first coupling signal 251 to the fourth coupling signal 254 (or the first coupling signal 251 to the fifth coupling signal 255). As a non-limiting example, the processor 210 may identify whether the first antenna 291 is covered (or in contact with an external object) by the external object, based on the at least portion of the first coupling signal 251 to the fourth coupling signal 254 (or the first coupling signal 251 to the fifth coupling signal 255). For example, the at least portion of the first coupling signal 251 to the fourth coupling signal 254 (or the first coupling signal 251 to the fifth coupling signal 255) may be usable, for the signal 242 to be transmitted through the first antenna 291 using the PA 221 connected to the first circuitry 281 in accordance with control of the switch 211, after the SRS 241 is respectively transmitted through the first antenna 291 to the fourth antenna 294 (or the first antenna 291 to the fifth antenna 295). For example, the at least a portion of the first coupling signal 251 to the fourth coupling signal 254 (or the first coupling signal 251 to the fifth coupling signal 255) may be usable to identify a Tx power of the signal 242 obtained using the PA 221 connected to the first circuitry 281 in accordance with control of the switch 211.

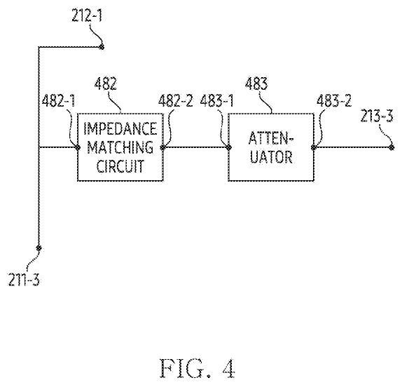

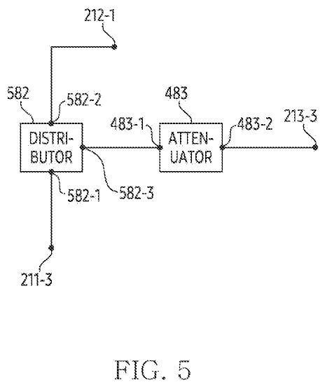

For example, the second circuitry 282 may be variously designed or implemented. The second circuitry 282 may be illustrated within the description of FIGS. 4 and 5.

FIGS. 4 and 5 illustrate an example of second circuitry.

Referring to FIG. 4, second circuitry 282 may include an impedance matching circuit 482 and an attenuator (e.g., including various circuitry) 483. For example, each of the impedance matching circuit 482 and the attenuator 483 may be used for each of a second coupling signal 252 to a fourth coupling signal 254 (or the second coupling signal 252 to a fifth coupling signal 255). For example, the impedance matching circuit 482 may include a first terminal 482-1 connected to a first terminal 212-1 of a switch 212 and connected to a third terminal 211-3 of a switch 211, and a second terminal 482-2 connected to a first terminal 483-1 of the attenuator 483. For example, the attenuator 483 may include the first terminal 483-1 connected to the second terminal 482-2 of the impedance matching circuit 482 and a second terminal 483-2 connected to a third terminal 213-3 of a switch 213.

Referring to FIG. 5, the second circuitry 282 may include a signal distributor 582 (or a power distributor (e.g., including various circuitry) 582) and the attenuator (e.g., including various circuitry) 483. For example, the second circuitry 282 may include the signal distributor 582 replacing the impedance matching circuit 482. For example, the signal distributor 582 may include a first terminal 582-1 connected to the third terminal 211-3 of the switch 211, a second terminal 582-2 connected to the first terminal 212-1 of the switch 212, and a third terminal 582-3 connected to the first terminal 483-1 of the attenuator 483. For example, the attenuator 483 may include the first terminal 483-1 connected to the third terminal 582-3 of the distributor 582 and the second terminal 483-2 connected to the third terminal 213-3 of the switch 213.

Referring back to FIG. 2, unlike the second antenna 292 to the fourth antenna 294 (or the second antenna 292 to the fifth antenna 295), the first antenna 291 may be further used for transmission of the signal 242. For example, unlike the first antenna 291, the second antenna 292 to the fourth antenna 294 (or the second antenna 292 to the fifth antenna 295) may be mainly used for receiving a signal from an external electronic device. For example, the second antenna 292 to the fourth antenna 294 (or the second antenna 292 to the fifth antenna 295) may be used for transmission of the SRS 241, but a main function of each of the second antenna 292 to the fourth antenna 294 (or the second antenna 292 to the fifth antenna 295) may be reception. For example, the SRS 241 may be transmitted through the second antenna 292 to the fourth antenna 294 (or the second antenna 292 to the fifth antenna 295) as well as the first antenna 291, in order to increase throughput of each of the signal 232 to the signal 234 (or the signal 232 to the signal 235) received through each of the second antenna 292 to the fourth antenna 294 (or the second antenna 292 to the fifth antenna 295).

For example, the signal 242 may be transmitted through the first antenna 291 after the SRS 241 is transmitted through the first antenna 291 to the fourth antenna 294 (or the first antenna 291 to the fifth antenna 295). For example, the processor 210 may control the switch 211 and the switch 214 for the transmission of the signal 242. For example, the processor 210 may control the switch 214 to connect the third terminal 214-3 to the first terminal 214-1 from among the first terminal 214-1 and the second terminal 214-2, in order to transmit the signal 242 through the first antenna 291. For example, the processor 210 may control the switch 211 to connect the first terminal 211-1 to the second terminal 211-2 from among the second terminal 211-2 and the third terminal 211-3, in order to transmit the signal 242 through the first antenna 291.

As described above, the electronic device 200 may obtain the second coupling signal 252 to the fourth coupling signal 254 (or the second coupling signal 252 to the fifth coupling signal 255), as well as the first coupling signal 251, by including the switch 213 and the second circuitry 282. For example, the electronic device 200 may increase throughput of the signal 242, based at least in part on the second coupling signal 252 to the fourth coupling signal 254 (or the second coupling signal 252 to the fifth coupling signal 255).

For example, since the switch 213 is located outside a path (e.g., path from the PA 221 to each of the second antenna 292 to the fourth antenna 294 (or the second antenna 292 to the fifth antenna 295)) of the SRS 241 transmitted through each of the second antenna 292 to the fourth antenna 294 (or the second antenna 292 to the fifth antenna 295), the electronic device 200 may reduce insertion loss capable of being caused in the electronic device 200. For example, since the second coupling signal 252 to the fourth coupling signal 254 (or the second coupling signal 252 to the fifth coupling signal 255) partially share a path of the RFIC 220 with the first coupling signal 251, the electronic device 200 may provide a more efficient mounting space.

For example, since the electronic device 200 may identify a state of a wireless environment that changes while the SRS 241 is transmitted through each of the second antenna 292 to the fourth antenna 294 (or the second antenna 292 to the fifth antenna 295) based at least in part on the second coupling signal 252 to the fourth coupling signal 254 (or the second coupling signal 252 to the fifth coupling signal 255), the electronic device 200 may provide an enhanced communication service.

For example, since the electronic device 200 transmits the SRS 241 through each of the first antenna 291 to the fourth antenna 294 (or the first antenna 291 to the fifth antenna 295), the electronic device 200 may increase throughput of each of the signal 231 to the signal 234 (or the signal 231 to the signal 235).

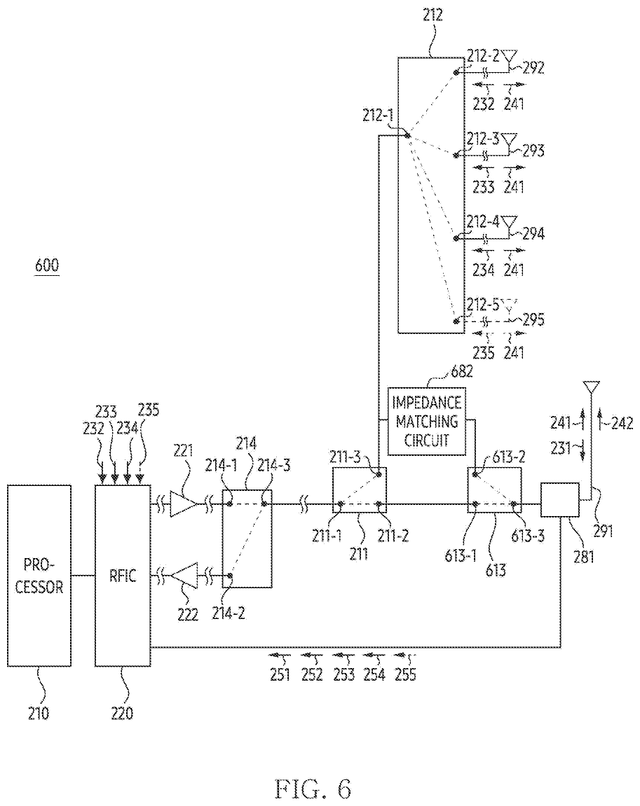

For example, an electronic device may include at least one other component that replaces the second circuitry 282 and the switch 213 of the electronic device 200, in order to obtain the second coupling signal 252 to the fourth coupling signal 254 (or the second coupling signal 252 to the fifth coupling signal 255). For example, the electronic device may include a switch to form a path for obtaining a portion of the SRS 241 (e.g., a portion of power of the SRS 241) as the at least one other component. The at least one other component may be illustrated within the description of FIGS. 6, 7, 8 and 9 below.

FIGS. 6 to 9 illustrate an exemplary electronic device including a circuit that is coupled with an antenna and identifies characteristics of a signal transmitted via one or more antennas different from the antenna.

Referring to FIG. 6, an electronic device 600 may include a processor (e.g., including processing circuitry) 210, an RFIC 220, a PA 221, an LNA 222, a switch 212, a switch 214, a switch 613, first circuitry 281, an impedance matching circuit 682, and a plurality of antennas. For example, the plurality of antennas may include a first antenna 291 to a fourth antenna 294. For example, the plurality of antennas may further include a fifth antenna 295.

For example, the switch 613 may be included within at least a portion of a wireless communication module 1292 of FIG. 12 and/or at least a portion of an antenna module 1297 of FIG. 12, or may at least partially correspond to the wireless communication module 1292 of FIG. 12 and/or the antenna module 1297 of FIG. 12. Although not illustrated in FIG. 6, the switch 613 may be included within one or more radio frequency front ends (RFFEs) of the electronic device 200.

For example, the processor 210 may include various processing circuitry. For example, as used herein, including the claims, the term “processor” may include various processing circuitry, including at least one processor, wherein one or more of at least one processor may be configured to perform various functions described herein. Additionally, the at least one processor may include a combination of processors performing various of the recited/disclosed functions. At least one processor may execute program instructions to achieve or perform various functions. The processor 210 may control the switch 211, the switch 214, and the switch 613, in order to transmit the SRS 241 through the first antenna 291. For example, the processor 210 may control the switch 214 to connect a third terminal 214-3 to a first terminal 214-1 from among the first terminal 214-1 and a second terminal 214-2, in order to transmit the SRS 241 through the first antenna 291. For example, the processor 210 may control the switch 211 to connect a first terminal 211-1 to a second terminal 211-2 from among the second terminal 211-2 and a third terminal 211-3, in order to transmit the SRS 241 through the first antenna 291. For example, the processor 210 may control the switch 613 to connect a third terminal 613-3 to a first terminal 613-1 from among the first terminal 613-1 and a second terminal 613-2, in order to transmit the SRS 241 through the first antenna 291. For example, the processor 210 may obtain the first coupling signal 251 of the SRS 241 transmitted through the first antenna 291, through the RFIC 220 from the first circuitry 281.

For example, the processor 210 may control the switch 211, the switch 212, and the switch 214, in order to transmit the SRS 241 through a second antenna 292. For example, the processor 210 may control the switch 214 to connect the third terminal 214-3 to the first terminal 214-1 from among the first terminal 214-1 and the second terminal 214-2, in order to transmit the SRS 241 through the second antenna 292. For example, the processor 210 may control the switch 211 to connect the first terminal 211-1 to the third terminal 211-3 of the second terminal 211-2 and the third terminal 211-3, in order to transmit the SRS 241 through the second antenna 292. For example, the processor 210 may control the switch 212 to connect a first terminal 212-1 to a second terminal 212-2 from among the second terminal 212-2 to a fifth terminal 212-5, in order to transmit the SRS 241 through the second antenna 292. For example, the processor 210 may control the switch 613 to obtain a second coupling signal 252 of the SRS 241 transmitted through the second antenna 292. For example, the processor 210 may control the switch 613 so that a portion (e.g., a portion of power of the SRS 241) of the SRS 241 output from the third terminal 211-3 is provided to the first circuitry 281 through the impedance matching circuit 682. For example, the processor 210 may control the switch 613 to connect the third terminal 613-3 to the second terminal 613-2 from among the first terminal 613-1 and the second terminal 613-2. For example, the portion of the SRS 241 may be input to the first circuitry 281 in accordance with the control of the switch 613. For example, the second coupling signal 252 may be provided from the first circuitry 281 to the RFIC 220, based on the portion of the SRS 241. For example, the processor 210 may obtain the second coupling signal 252 through the RFIC 220.

As a non-limiting example, the second antenna 292 may be adjacent to one or more cameras (e.g., at least a portion of the camera module 1280 of FIG. 12) of the electronic device 600. For example, power of the portion of the SRS 241 may be identified as a value to reduce interference to the one or more cameras caused due to transmitting the SRS 241 through the second antenna 292.

For example, the processor 210 may control the switch 211, the switch 212, and the switch 214, in order to transmit the SRS 241 through the third antenna 293. For example, the processor 210 may control the switch 214 to connect the third terminal 214-3 to the first terminal 214-1 from among the first terminal 214-1 and the second terminal 214-2, in order to transmit the SRS 241 through the third antenna 293. For example, the processor 210 may control the switch 211 to connect the first terminal 211-1 to the third terminal 211-3 from among the second terminal 211-2 and the third terminal 211-3, in order to transmit the SRS 241 through the third antenna 293. For example, the processor 210 may control the switch 212 to connect the first terminal 212-1 to the third terminal 212-3 from among the second terminal 212-2 to the fifth terminal 212-5, in order to transmit the SRS 241 through the third antenna 293. For example, the processor 210 may control the switch 613 to obtain a third coupling signal 253 of the SRS 241 transmitted through the third antenna 293. For example, the processor 210 may control the switch 613 so that a portion of the SRS 241 output from the third terminal 211-3 is provided to the first circuitry 281 through the impedance matching circuit 682. For example, the processor 210 may control the switch 613 to connect the third terminal 613-3 to the second terminal 613-2 from among the first terminal 613-1 and the second terminal 613-2. For example, the portion of the SRS 241 may be input to the first circuitry 281 in accordance with the control of the switch 613. For example, the third coupling signal 253 may be provided from the first circuitry 281 to the RFIC 220, based on the portion of the SRS 241. For example, the processor 210 may obtain the third coupling signal 253 through the RFIC 220.

As a non-limiting example, the third antenna 293 may be adjacent to one or more cameras (e.g., at least a portion of the camera module 1280 of FIG. 12) of the electronic device 600. For example, power of the portion of the SRS 241 may be identified as a value to reduce interference to the one or more cameras caused due to transmitting the SRS 241 through the third antenna 293.

For example, the processor 210 may control the switch 211, the switch 212, and the switch 214, in order to transmit the SRS 241 through the fourth antenna 294. For example, the processor 210 may control the switch 214 to connect the third terminal 214-3 to the first terminal 214-1 from among the first terminal 214-1 and the second terminal 214-2, in order to transmit the SRS 241 through the fourth antenna 294. For example, the processor 210 may control the switch 211 to connect the first terminal 211-1 to the third terminal 211-3 from among the second terminal 211-2 and the third terminal 211-3, in order to transmit the SRS 241 through the fourth antenna 294. For example, the processor 210 may control the switch 212 to connect the first terminal 212-1 to a fourth terminal 212-4 from among the second terminal 212-2 to the fifth terminal 212-5, in order to transmit the SRS 241 through the fourth antenna 294. For example, the processor 210 may control the switch 613 to obtain a fourth coupling signal 254 of the SRS 241 transmitted through the fourth antenna 294. For example, the processor 210 may control the switch 613 so that a portion of the SRS 241 output from the third terminal 211-3 is provided to the first circuitry 281 through the impedance matching circuit 682. For example, the processor 210 may control the switch 613 to connect the third terminal 613-3 to the second terminal 613-2 from among the first terminal 613-1 and the second terminal 613-2. For example, the portion of the SRS 241 may be input to the first circuitry 281 in accordance with the control of the switch 613. For example, the fourth coupling signal 254 may be provided from the first circuitry 281 to the RFIC 220 based on the portion of the SRS 241. For example, the processor 210 may obtain the fourth coupling signal 254 through the RFIC 220.

As a non-limiting example, the fourth antenna 294 may be adjacent to one or more cameras (e.g., at least a portion of the camera module 1280 of FIG. 12) of the electronic device 600. For example, power of the portion of the SRS 241 may be identified as a value to reduce interference to the one or more cameras caused due to transmitting the SRS 241 through the fourth antenna 294.

For example, when the fifth antenna 295 is included in the plurality of antennas, the processor 210 may control the switch 211, the switch 212, and the switch 214, in order to transmit the SRS 241 through the fifth antenna 295. For example, the processor 210 may control the switch 214 to connect the third terminal 214-3 to the first terminal 214-1 from among the first terminal 214-1 and the second terminal 214-2, in order to transmit the SRS 241 through the fifth antenna 295. For example, the processor 210 may control the switch 211 to connect the first terminal 211-1 to the third terminal 211-3 from among the second terminal 211-2 and the third terminal 211-3, in order to transmit the SRS 241 through the fifth antenna 295. For example, the processor 210 may control the switch 212 to connect the first terminal 212-1 to the fifth terminal 212-5 from among the second terminal 212-2 to the fifth terminal 212-5, in order to transmit the SRS 241 through the fifth antenna 295. For example, the processor 210 may control the switch 613 to obtain a fifth coupling signal 255 of the SRS 241 transmitted through the fifth antenna 295. For example, the processor 210 may control the switch 613 so that a portion of the SRS 241 output from the third terminal 211-3 is provided to the first circuitry 281 through the impedance matching circuit 682. For example, the processor 210 may control the switch 613 to connect the third terminal 613-3 to the second terminal 613-2 from among the first terminal 613-1 and the second terminal 613-2. For example, the portion of the SRS 241 may be input to the first circuitry 281 in accordance with the control of the switch 613. For example, the fifth coupling signal 255 may be provided from the first circuitry 281 to the RFIC 220 based on the portion of the SRS 241. For example, the processor 210 may obtain the fifth coupling signal 255 through the RFIC 220.

As a non-limiting example, the fifth antenna 295 may be adjacent to one or more cameras (e.g., at least a portion of the camera module 1280 of FIG. 12) of the electronic device 600. For example, power of the portion of the SRS 241 may be identified as a value to reduce interference to the one or more cameras caused due to transmitting the SRS 241 through the fifth antenna 295.

As a non-limiting example, while the SRS 241 is transmitted through each of the second antenna 292 to the fourth antenna 294 (or the second antenna 292 to the fifth antenna 295), a portion of the SRS 241 transmitted through the first antenna may have power that is not received by another electronic device (e.g., a base station). As a non-limiting example, while transmitting the SRS 241 through each of the second antenna 292 to the fourth antenna 294 (or the second antenna 292 to the fifth antenna 295), the first circuitry 281 may be configured to substantially prevent and/or avoid a portion of the SRS 241 from being transmitted through the first antenna 291.

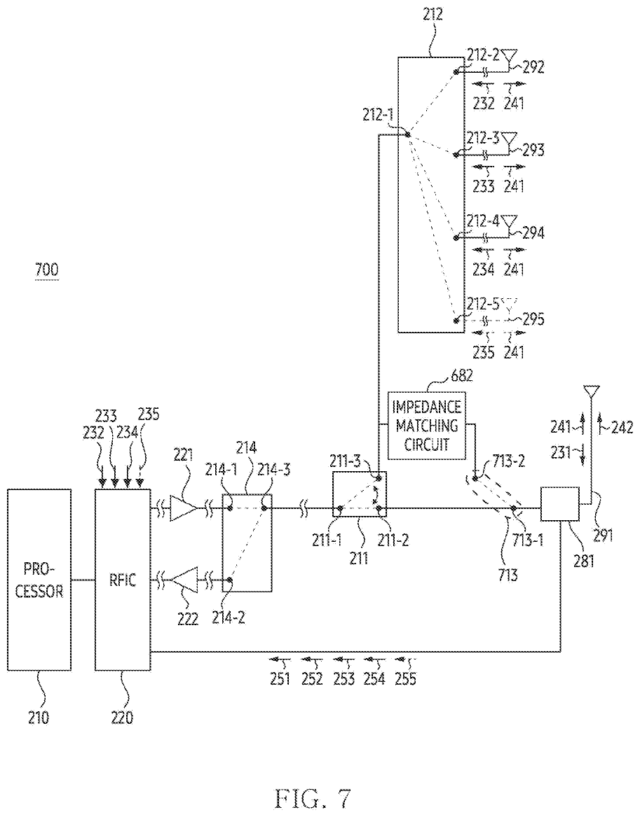

For example, referring to FIG. 7, the switch 613 may be replaced with a switch 713. For example, the switch 713 may include a terminal 713-2, which is connected to the third terminal 211 through the impedance matching circuit 682 and is connectable to a node 713-1 on (or within) a path between the second terminal 211-2 of the switch 211 and the first circuitry 281. For example, when transmitting the SRS 241 through the first antenna 291, the processor 210 may control the switch 713 to disconnect the terminal 713-2 from the node 713-1. For example, when transmitting the SRS 241 through each of the second antenna 292 to the fourth antenna 294 (or the second antenna 292 to the fifth antenna 295), the processor 210 may control the switch 713 to connect the terminal 713-2 to the node 713-1.

As a non-limiting example, while the SRS 241 is transmitted through each of the second antenna 292 to the fourth antenna 294 (or the second antenna 292 to the fifth antenna 295), a portion of the SRS 241 transmitted through the first antenna may have power that is not received by another electronic device (e.g., a base station). As a non-limiting example, the first circuitry 281 may be configured to substantially prevent and/or avoid a portion of the SRS 241 from being transmitted through the first antenna 291 while transmitting the SRS 241 through each of the second antenna 292 to the fourth antenna 294 (or the second antenna 292 to the fifth antenna 295).

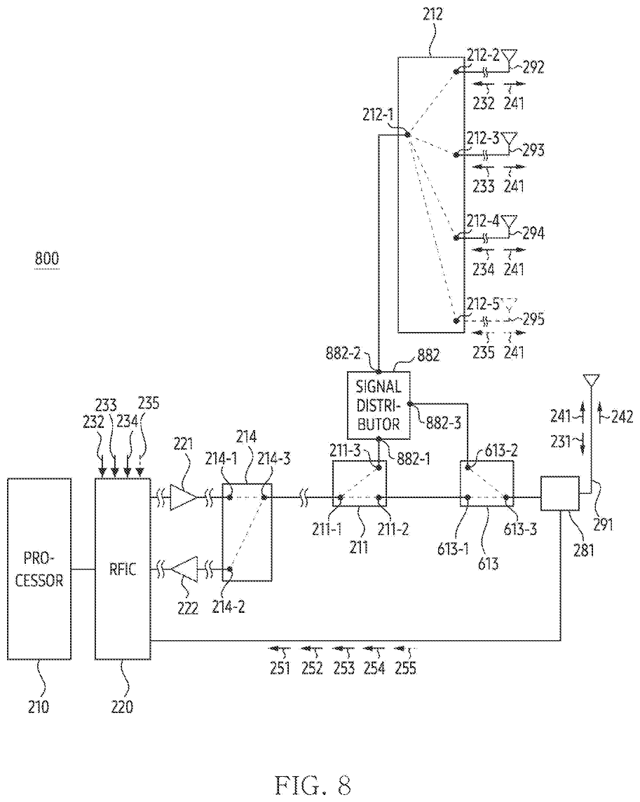

For example, referring to FIG. 8, the impedance matching circuit 682 of FIG. 6 may be replaced with a signal distributor (or power distributor) (e.g., including various circuitry) 882. For example, the signal distributor 882 may include a first terminal 882-1 connected to the third terminal 211-3 of the switch 211, a second terminal 882-2 connected to the first terminal 212-1 of the switch 212, and a third terminal 882-3 connected to the second terminal 613-2 of the switch 613. For example, the signal distributor 882 may be configured to provide a portion of the SRS 241 output from the third terminal 211-3 to the first circuitry 281.

As a non-limiting example, while the SRS 241 is transmitted through each of the second antenna 292 to the fourth antenna 294 (or the second antenna 292 to the fifth antenna 295), a portion of the SRS 241 transmitted through the first antenna may have power that is not received by another electronic device (e.g., a base station). As a non-limiting example, the first circuitry 281 may be configured to substantially prevent and/or avoid a portion of the SRS 241 from being transmitted through the first antenna 291 while transmitting the SRS 241 through each of the second antenna 292 to the fourth antenna 294 (or the second antenna 292 to the fifth antenna 295).

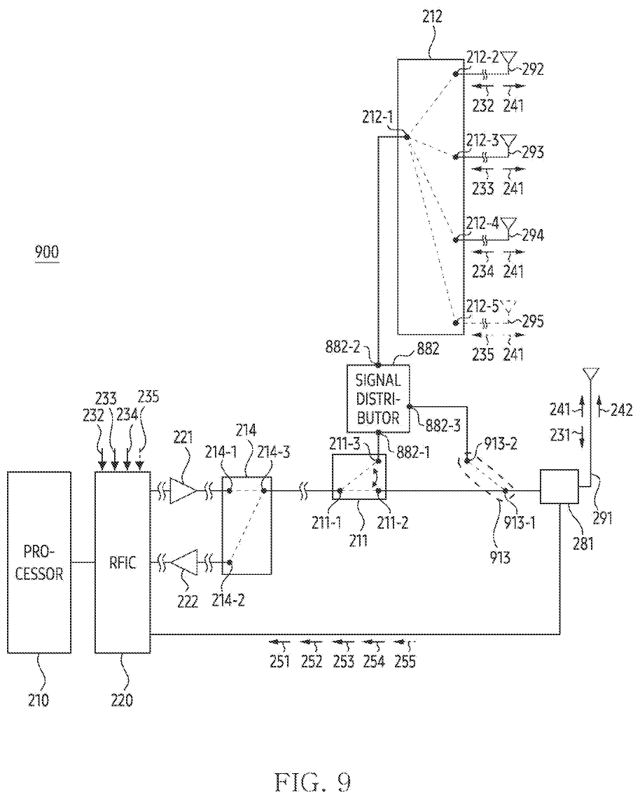

For example, referring to FIG. 9, the switch 613 of FIG. 8 may be replaced with a switch 913. For example, the switch 913 may include a terminal 913-2, which is connected to a third terminal 882-3 of the signal distributor 882 and is connectable to a node 913-1 on (or within) a path between the second terminal 211-2 of the switch 211 and the first circuitry 281. For example, the processor 210 may control the switch 913 to disconnect the terminal 913-2 from the node 913-1 when transmitting the SRS 241 through the first antenna 291. For example, the processor 210 may control the switch 913 to connect the terminal 913-2 to the node 913-1 when transmitting the SRS 241 through each of the second antenna 292 to the fourth antenna 294 (or the second antenna 292 to the fifth antenna 295). As a non-limiting example, while the SRS 241 is transmitted through each of the second antenna 292 to the fourth antenna 294 (or the second antenna 292 to the fifth antenna 295), a portion of the SRS 241 transmitted through the first antenna may have power that is not received by another electronic device (e.g., a base station). As a non-limiting example, the first circuitry 281 may be configured to substantially prevent and/or avoid a portion of the SRS 241 from being transmitted through the first antenna 291 while transmitting the SRS 241 through each of the second antenna 292 to the fourth antenna 294 (or the second antenna 292 to the fifth antenna 295).

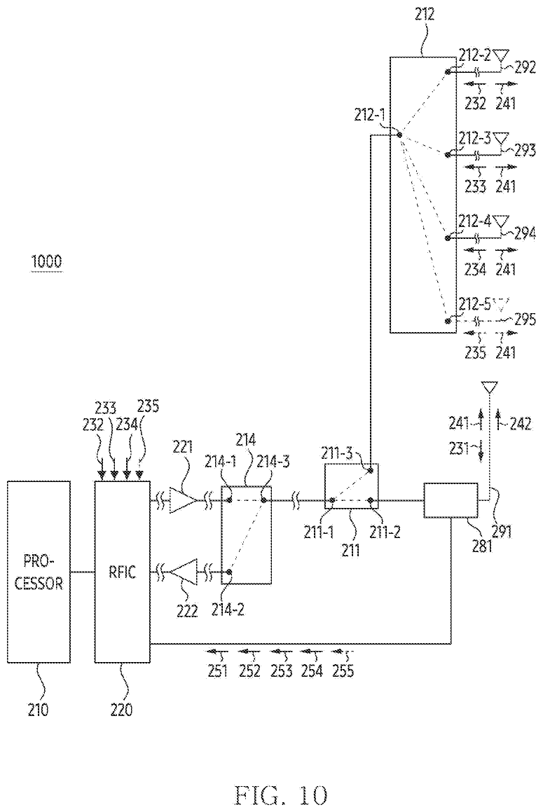

For example, the at least one other component may be designed or implemented by changing the switch 211. For example, the change of the switch 211 may be illustrated within the description of FIG. 10.

FIG. 10 illustrates, in order to identify a characteristic of a signal transmitted through one or more antennas, an exemplary electronic device including a switch connected to a circuit coupled with an antenna different from the one or more antennas.

Referring to FIG. 10, an electronic device 1000 may include a processor (e.g., including processing circuitry) 210, an RFIC 220, a PA 221, an LNA 222, a switch 211, a switch 212, a switch 214, first circuitry 281, and a plurality of antennas. For example, the plurality of antennas may include a first antenna 291 to a fourth antenna 294. For example, the plurality of antennas may further include a fifth antenna 295.

For example, compared with the first terminal 211-1 of the switch 211 of FIGS. 2, 3, 4, 5, 6, 7, 8, and 9, a first terminal 211-1 of the switch 211 may be connected to both a second terminal 211-2 and a third terminal 211-3. For example, the switch 211 of FIG. 10 may further have a state of connecting the first terminal 211-1 to the third terminal 211-3 (or the second terminal 211-2) while connecting the first terminal 211-1 to the second terminal 211-2 (or the third terminal 211-3), compared with the switch 211 of FIGS. 2, 3, 4, 5, 6, 7, 8 and 9.

For example, the processor 210 may control the switch 211 and the switch 214, in order to transmit the SRS 241 through the first antenna 291. For example, the processor 210 may control the switch 214 to connect a third terminal 214-3 to a first terminal 214-1 from among the first terminal 214-1 and a second terminal 214-2, in order to transmit the SRS 241 through the first antenna 291. For example, the processor 210 may control the switch 211 to connect the first terminal 211-1 to the second terminal 211-2 from among the second terminal 211-2 and the third terminal 211-3, in order to transmit the SRS 241 through the first antenna 291. For example, the processor 210 may obtain a first coupling signal 251 of the SRS 241 transmitted through the first antenna 291, through the RFIC 220 from the first circuitry 281.

For example, the processor 210 may control the switch 211, the switch 212, and the switch 214, in order to transmit the SRS 241 through the second antenna 292. For example, the processor 210 may control the switch 214 to connect the third terminal 214-3 to the first terminal 214-1 from among the first terminal 214-1 and the second terminal 214-2, in order to transmit the SRS 241 through the second antenna 292. For example, the processor 210 may control the switch 211 to connect the first terminal 211-1 to each of the second terminal 211-2 and the third terminal 211-3, in order to transmit the SRS 241 through the second antenna 292. For example, the switch 211 may have a state of connecting the first terminal 211-1 to both the second terminal 211-2 and the third terminal 211-3, unlike the switch 211 of FIGS. 2, 3, 4, 5, 6, 7, 8, and 9. For example, the processor 210 may control the switch 212 to connect the first terminal 212-1 to the second terminal 212-2 from among the second terminal 212-2 to a fifth terminal 212-5, in order to transmit the SRS 241 through the second antenna 292. For example, a portion (e.g., a portion of power of the SRS 241) of the SRS 241 output from the PA 221 may be input to the first circuitry 281 through a connection between the first terminal 211-1 and the second terminal 211-2. For example, the processor 210 may obtain a second coupling signal 252 provided from the first circuitry 281 based on the portion of the SRS 241, through the RFIC 220.

For example, the processor 210 may control the switch 211, the switch 212, and the switch 214, in order to transmit the SRS 241 through the third antenna 293. For example, the processor 210 may control the switch 214 to connect the third terminal 214-3 to the first terminal 214-1 from among the first terminal 214-1 and the second terminal 214-2, in order to transmit the SRS 241 through the third antenna 293. For example, the processor 210 may control the switch 211 to connect the first terminal 211-1 to each of the second terminal 211-2 and the third terminal 211-3, in order to transmit the SRS 241 through the third antenna 293. For example, the processor 210 may control the switch 212 to connect the first terminal 212-1 to the third terminal 212-3 from among the second terminal 212-2 to the fifth terminal 212-5, in order to transmit the SRS 241 through the third antenna 293. For example, a portion of the SRS 241 output from the PA 221 may be input to the first circuitry 281 through a connection between the first terminal 211-1 and the second terminal 211-2. For example, the processor 210 may obtain a third coupling signal 253 provided from the first circuitry 281 based on the portion of the SRS 241, through the RFIC 220.

For example, the processor 210 may control the switch 211, the switch 212, and the switch 214, in order to transmit the SRS 241 through the fourth antenna 294. For example, the processor 210 may control the switch 214 to connect the third terminal 214-3 to the first terminal 214-1 from among the first terminal 214-1 and the second terminal 214-2, in order to transmit the SRS 241 through the fourth antenna 294. For example, the processor 210 may control the switch 211 to connect the first terminal 211-1 to each of the second terminal 211-2 and the third terminal 211-3, in order to transmit the SRS 241 through the fourth antenna 294. For example, the processor 210 may control the switch 212 to connect the first terminal 212-1 to a fourth terminal 212-4 from among the second terminal 212-2 to the fifth terminal 212-5, in order to transmit the SRS 241 through the fourth antenna 294. For example, a portion of the SRS 241 output from the PA 221 may be input to the first circuitry 281 through a connection between the first terminal 211-1 and the second terminal 211-2. For example, the processor 210 may obtain a fourth coupling signal 254 provided from the first circuitry 281 based on the portion of the SRS 241, through the RFIC 220.

For example, when the fifth antenna 295 is included in the plurality of antennas, the processor 210 may control the switch 211, the switch 212, and the switch 214, in order to transmit the SRS 241 through the fifth antenna 295. For example, the processor 210 may control the switch 214 to connect the third terminal 214-3 to the first terminal 214-1 from among the first terminal 214-1 and the second terminal 214-2, in order to transmit the SRS 241 through the fifth antenna 295. For example, the processor 210 may control the switch 211 to connect the first terminal 211-1 to each of the second terminal 211-2 and the third terminal 211-3, in order to transmit the SRS 241 through the fifth antenna 295. For example, the processor 210 may control the switch 212 to connect the first terminal 212-1 to the fifth terminal 212-5 from among the second terminal 212-2 to the fifth terminal 212-5, in order to transmit the SRS 241 through the fifth antenna 295. For example, a portion of the SRS 241 output from the PA 221 may be input to the first circuitry 281 through a connection between the first terminal 211-1 and the second terminal 211-2. For example, the processor 210 may obtain a fifth coupling signal 255 provided from the first circuitry 281 based on the portion of the SRS 241, through the RFIC 220.

As a non-limiting example, while the SRS 241 is transmitted through each of the second antenna 292 to the fourth antenna 294 (or the second antenna 292 to the fifth antenna 295), a portion of the SRS 241 transmitted through the first antenna may have power that is not received by another electronic device (e.g., a base station). As a non-limiting example, the first circuitry 281 may be configured to substantially prevent and/or avoid a portion of the SRS 241 from being transmitted through the first antenna 291 while transmitting the SRS 241 through each of the second antenna 292 to the fourth antenna 294 (or the second antenna 292 to the fifth antenna 295).

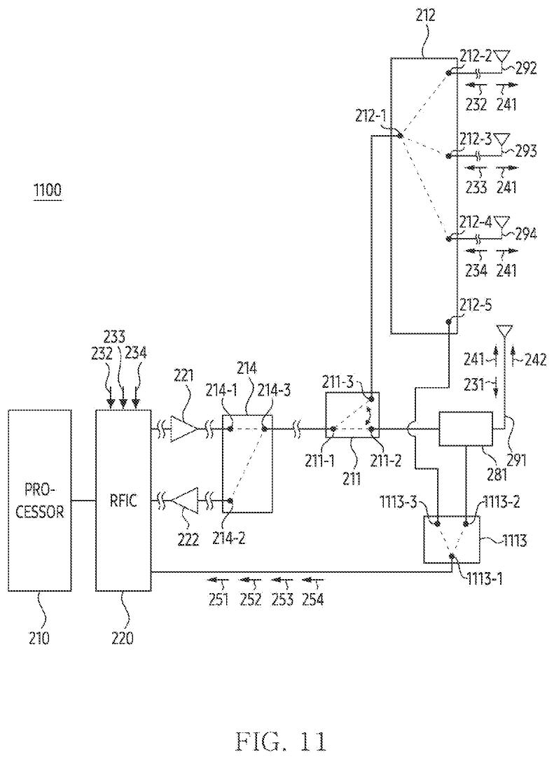

For example, the at least one other component may be designed or implemented as a switch 212 that includes a terminal disconnected from all of the plurality of antennas. For example, an electronic device including the switch 212 that includes the terminal disconnected from all of the plurality of antennas may be illustrated within the description of FIG. 11.

FIG. 11 illustrates, in order to identify a characteristic of a signal transmitted through one or more antennas, an exemplary electronic device including a switch that includes one or more terminals respectively connected to one or more antennas and a terminal disconnected from the one or more antennas.

Referring to FIG. 11, an electronic device 1100 may include a processor (e.g., including processing circuitry) 210, an RFIC 220, a PA 221, an LNA 222, a switch 211, a switch 212, a switch 214, a switch 1113, first circuitry 281, and a plurality of antennas. For example, the plurality of antennas may include a first antenna 291 to a fourth antenna 294. For example, the second antenna 292 to the fourth antenna 294 may be connected to the switch 212.

For example, the switch 212 may include a fifth terminal 212-5, which is not connected to any antenna, unlike the fifth terminal 212-5 of the switch 212 of FIGS. 2, 3, 4, 5, 6, 7, 8, 9, and 10. For example, the processor 210 may obtain a second coupling signal 252 to a fourth coupling signal 254 using a switch 1113 having a third terminal 1113-3 connected to the fifth terminal 212-5 of the switch 212.

For example, the processor 210 may control the switch 211 and the switch 214 in order to transmit the SRS 241 through the first antenna 291. For example, the processor 210 may control the switch 214 to connect a third terminal 214-3 to a first terminal 214-1 from among the first terminal 214-1 and a second terminal 214-2, in order to transmit the SRS 241 through the first antenna 291. For example, the processor 210 may control the switch 211 to connect the first terminal 211-1 to the second terminal 211-2 from among the second terminal 211-2 and the third terminal 211-3, in order to transmit the SRS 241 through the first antenna 291. For example, the processor 210 may control the switch 1113 to obtain a first coupling signal 251 of the SRS 241 transmitted through the first antenna 291. For example, the processor 210 may connect a first terminal 1113-1 to a second terminal 1113-2 from among the second terminal 1113-2 and a third terminal 1113-3, in order to obtain the first coupling signal 251 through the RFIC 220. For example, the processor 210 may obtain the first coupling signal 251 from the first circuitry 281 through the RFIC 220 in accordance with the control of the switch 1113.

For example, the processor 210 may control the switch 211, the switch 212, and the switch 214, in order to transmit the SRS 241 through the second antenna 292. For example, the processor 210 may control the switch 214 to connect the third terminal 214-3 to the first terminal 214-1 from among the first terminal 214-1 and the second terminal 214-2, in order to transmit the SRS 241 through the second antenna 292. For example, the processor 210 may control the switch 211 to connect the first terminal 211-1 to the third terminal 211-3 from among the second terminal 211-2 and the third terminal 211-3, in order to transmit the SRS 241 through the second antenna 292. For example, the processor 210 may control the switch 212 to connect the first terminal 212-1 to the second terminal 212-2 from among the second terminal 212-2 to the fifth terminal 212-5, in order to transmit the SRS 241 through the second antenna 292. For example, a portion of the SRS 241 input to the second terminal 212-2 in accordance with the control of the switch 212 may be transferred to the fifth terminal 212-5. For example, the transfer of the portion of the SRS 241 to the fifth terminal 212-5 may be caused by an isolation characteristic of the switch 212. For example, since the portion of the SRS 241 transferred to the fifth terminal 212-5 includes a characteristic of the SRS 241 transmitted through the second antenna 292, the portion of the SRS 241 transferred to the fifth terminal 212-5 may be used as a coupling signal. For example, the processor 210 may control the switch 1113 to obtain the portion of the SRS 241 through the RFIC 220 as a second coupling signal 252. For example, the processor 210 may connect the first terminal 1113-1 to the third terminal 1113-3 from among the second terminal 1113-2 and the third terminal 1113-3, in order to obtain the second coupling signal 252 through the RFIC 220. For example, the processor 210 may obtain the second coupling signal 252 from the first circuitry 281 in accordance with the control of the switch 1113, through the RFIC 220.

For example, the processor 210 may control the switch 211, the switch 212, and the switch 214, in order to transmit the SRS 241 through the third antenna 293. For example, the processor 210 may control the switch 214 to connect the third terminal 214-3 to the first terminal 214-1 from among the first terminal 214-1 and the second terminal 214-2, in order to transmit the SRS 241 through the third antenna 293. For example, the processor 210 may control the switch 211 to connect the first terminal 211-1 to the third terminal 211-3 from among the second terminal 211-2 and the third terminal 211-3, in order to transmit the SRS 241 through the third antenna 293. For example, the processor 210 may control the switch 212 to connect the first terminal 212-1 to the third terminal 212-3 from among the second terminal 212-2 to the fifth terminal 212-5, in order to transmit the SRS 241 through the third antenna 293. For example, a portion of the SRS 241 input to the first terminal 212-2 in accordance with the control of the switch 212 may be transferred to the fifth terminal 212-5. As a non-limiting example, the transfer of the portion of the SRS 241 to the fifth terminal 212-5 may be caused by an isolation characteristic of the switch 212. For example, since the portion of the SRS 241 transferred to the fifth terminal 212-5 includes a characteristic of the SRS 241 transmitted through the third antenna 293, the portion of the SRS 241 transferred to the fifth terminal 212-5 may be used as a coupling signal. For example, the processor 210 may control the switch 1113 to obtain the portion of the SRS 241 through the RFIC 220 as a third coupling signal 253. For example, the processor 210 may connect the first terminal 1113-1 to the third terminal 1113-3 from among the second terminal 1113-2 and the third terminal 1113-3, in order to obtain the third coupling signal 253 through the RFIC 220. For example, the processor 210 may obtain the third coupling signal 253 from the first circuitry 281 through the RFIC 220 in accordance with the control of the switch 1113.

For example, the processor 210 may control the switch 211, the switch 212, and the switch 214 to transmit the SRS 241 through the fourth antenna 294. For example, the processor 210 may control the switch 214 to connect the third terminal 214-3 to the first terminal 214-1 from among the first terminal 214-1 and the second terminal 214-2, in order to transmit the SRS 241 through the fourth antenna 294. For example, the processor 210 may control the switch 211 to connect the first terminal 211-1 to the third terminal 211-3 from among the second terminal 211-2 and the third terminal 211-3, in order to transmit the SRS 241 through the fourth antenna 294. For example, the processor 210 may control the switch 212 to connect the first terminal 212-1 to the fourth terminal 212-4 from among the second terminal 212-2 to the fifth terminal 212-5, in order to transmit the SRS 241 through the fourth antenna 294. For example, a portion of the SRS 241 input to the first terminal 212-2 in accordance with the control of the switch 212 may be transferred to the fifth terminal 212-5. For example, the transfer of the portion of the SRS 241 to the fifth terminal 212-5 may be caused by an isolation characteristic of the switch 212. For example, since the portion of the SRS 241 transferred to the fifth terminal 212-5 includes a characteristic of the SRS 241 transmitted through the fourth antenna 294, the portion of the SRS 241 transferred to the fifth terminal 212-5 may be used as a coupling signal. For example, the processor 210 may control the switch 1113 to obtain the portion of the SRS 241 through the RFIC 220 as a fourth coupling signal 254. For example, the processor 210 may connect the first terminal 1113-1 to the third terminal 1113-3 from among the second terminal 1113-2 and the third terminal 1113-3, in order to obtain the fourth coupling signal 254 through the RFIC 220. For example, the processor 210 may obtain the fourth coupling signal 254 from the first circuitry 281 through the RFIC 220 in accordance with the control of the switch 1113.

FIG. 12 is a block diagram of an electronic device 1201 in a network environment 1200, according to various embodiments. Referring to FIG. 12, in the network environment 1200, the electronic device 1201 (e.g., the electronic device 200 of FIG. 2, the electronic device 600 of FIG. 6, the electronic device 700 of FIG. 7, the electronic device 800 of FIG. 8, the electronic device 900 of FIG. 9, the electronic device 1000 of FIG. 10, or the electronic device 1100 of FIG. 11) may communicate with an electronic device 1202 through a first network 1298 (e.g., a short-range wireless communication network), or communicate with at least one of an electronic device 1204 and a server 1208 through a second network 1299 (e.g., a long-distance wireless communication network). According to an embodiment, the electronic device 1201 may communicate with the electronic device 1204 through the server 1208. According to an embodiment, the electronic device 1201 may include a processor 1220, a memory 1230, an input module 1250, a sound output module 1255, a display module 1260, an audio module 1270, a sensor module 1276, an interface 1277, a connecting terminal 1278, a haptic module 1279, a camera module 1280, a power management module 1288, a battery 1289, a communication module 1290, a subscriber identification module (SIM) 1296, and/or an antenna module 1297. In some embodiments, at least one of the components (e.g., the connecting terminal 1278) may be omitted from the electronic device 1201, or one or more other components may be added in the electronic device 1201. In some embodiments, some of the components (e.g., the sensor module 1276, the camera module 1280, or the antenna module 1297) may be implemented as a single component (e.g., the display module 1260).

The processor 1220 may execute, for example, software (e.g., a program 1240) to control at least one other component (e.g., a hardware or software component) of the electronic device 1201 coupled with the processor 1220, and may perform various data processing or computation. According to an embodiment, as at least part of the data processing or computation, the processor 1220 may store a command or data received from another component (e.g., the sensor module 1276 or the communication module 1290) in volatile memory 1232, process the command or the data stored in the volatile memory 1232, and store resulting data in non-volatile memory 1234. According to an embodiment, the processor 1220 may include a main processor 1221 (e.g., a central processing unit (CPU) or an application processor (AP)), or an auxiliary processor 1223 (e.g., a graphics processing unit (GPU), a neural processing unit (NPU), an image signal processor (ISP), a sensor hub processor, or a communication processor (CP)) that is operable independently from, or in conjunction with, the main processor 1221. For example, when the electronic device 1201 includes the main processor 1221 and the auxiliary processor 1223, the auxiliary processor 1223 may be adapted to consume less power than the main processor 1221, or to be specific to a specified function. The auxiliary processor 1223 may be implemented as separate from, or as part of the main processor 1221.

The auxiliary processor 1223 may control at least some of functions or states related to at least one component (e.g., the display module 1260, the sensor module 1276, or the communication module 1290) among the components of the electronic device 1201, instead of the main processor 1221 while the main processor 1221 is in an inactive (e.g., sleep) state, or together with the main processor 1221 while the main processor 1221 is in an active state (e.g., executing an application). According to an embodiment, the auxiliary processor 1223 (e.g., an image signal processor or a communication processor) may be implemented as part of another component (e.g., the camera module 1280 or the communication module 1290) functionally related to the auxiliary processor 1223. According to an embodiment, the auxiliary processor 1223 (e.g., the neural processing unit) may include a hardware structure specified for artificial intelligence model processing. An artificial intelligence model may be generated by machine learning. Such learning may be performed, e.g., by the electronic device 1201 where the artificial intelligence is performed or via a separate server (e.g., the server 1208). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1230 may store various data used by at least one component (e.g., the processor 1220 or the sensor module 1276) of the electronic device 1201. The various data may include, for example, software (e.g., the program 1240) and input data or output data for a command related thereto. The memory 1230 may include the volatile memory 1232 or the non-volatile memory 1234.

The program 1240 may be stored in the memory 1230 as software, and may include, for example, an operating system (OS) 1242, middleware 1244, or an application 1246.

The input module 1250 may receive a command or data to be used by another component (e.g., the processor 1220) of the electronic device 1201, from the outside (e.g., a user) of the electronic device 1201. The input module 1250 may include, for example, a microphone, a mouse, a keyboard, a key (e.g., a button), or a digital pen (e.g., a stylus pen).

The sound output module 1255 may output sound signals to the outside of the electronic device 1201. The sound output module 1255 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1260 may visually provide information to the outside (e.g., a user) of the electronic device 1201. The display module 1260 may include, for example, a display, a hologram device, or a projector and control circuit to control a corresponding one of the display, hologram device, and projector. According to an embodiment, the display module 1260 may include a touch sensor adapted to detect a touch, or a pressure sensor adapted to measure the intensity of force incurred by the touch.

The audio module 1270 may convert a sound into an electrical signal and vice versa. According to an embodiment, the audio module 1270 may obtain the sound via the input module 1250, or output the sound via the sound output module 1255 or a headphone of an external electronic device (e.g., an electronic device 1202) directly (e.g., wiredly) or wirelessly coupled with the electronic device 1201.

The sensor module 1276 may detect an operational state (e.g., power or temperature) of the electronic device 1201 or an environmental state (e.g., a state of a user) external to the electronic device 1201, and then generate an electrical signal or data value corresponding to the detected state. According to an embodiment, the sensor module 1276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1277 may support one or more specified protocols to be used for the electronic device 1201 to be coupled with the external electronic device (e.g., the electronic device 1202) directly (e.g., wiredly) or wirelessly. According to an embodiment, the interface 1277 may include, for example, a high definition multimedia interface (HDMI), a universal serial bus (USB) interface, a secure digital (SD) card interface, or an audio interface.

A connecting terminal 1278 may include a connector via which the electronic device 1201 may be physically connected with the external electronic device (e.g., the electronic device 1202). According to an embodiment, the connecting terminal 1278 may include, for example, a HDMI connector, a USB connector, a SD card connector, or an audio connector (e.g., a headphone connector).

The haptic module 1279 may convert an electrical signal into a mechanical stimulus (e.g., a vibration or a movement) or electrical stimulus which may be recognized by a user via his tactile sensation or kinesthetic sensation. According to an embodiment, the haptic module 1279 may include, for example, a motor, a piezoelectric element, or an electric stimulator.

The camera module 1280 may capture a still image or moving images. According to an embodiment, the camera module 1280 may include one or more lenses, image sensors, image signal processors, or flashes.

The power management module 1288 may manage power supplied to the electronic device 1201. According to an embodiment, the power management module 1288 may be implemented as at least part of, for example, a power management integrated circuit (PMIC).

The battery 1289 may supply power to at least one component of the electronic device 1201. According to an embodiment, the battery 1289 may include, for example, a primary cell which is not rechargeable, a secondary cell which is rechargeable, or a fuel cell.

The communication module 1290 may support establishing a direct (e.g., wired) communication channel or a wireless communication channel between the electronic device 1201 and the external electronic device (e.g., the electronic device 1202, the electronic device 1204, or the server 1208) and performing communication via the established communication channel. The communication module 1290 may include one or more communication processors that are operable independently from the processor 1220 (e.g., the application processor (AP)) and supports a direct (e.g., wired) communication or a wireless communication. According to an embodiment, the communication module 1290 may include a wireless communication module 1292 (e.g., a cellular communication module, a short-range wireless communication module, or a global navigation satellite system (GNSS) communication module) or a wired communication module 1294 (e.g., a local area network (LAN) communication module or a power line communication (PLC) module). A corresponding one of these communication modules may communicate with the external electronic device via the first network 1298 (e.g., a short-range communication network, such as Bluetooth™, wireless-fidelity (Wi-Fi) direct, or infrared data association (IrDA)) or the second network 1299 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1292 may identify and authenticate the electronic device 1201 in a communication network, such as the first network 1298 or the second network 1299, using subscriber information (e.g., international mobile subscriber identity (IMSI)) stored in the subscriber identification module 1296.

The wireless communication module 1292 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1292 may support a high-frequency band (e.g., the mm Wave band) to achieve, e.g., a high data transmission rate. The wireless communication module 1292 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1292 may support various requirements specified in the electronic device 1201, an external electronic device (e.g., the electronic device 1204), or a network system (e.g., the second network 1299). According to an embodiment, the wireless communication module 1292 may support a peak data rate (e.g., 20 Gbps or more) for implementing eMBB, loss coverage (e.g., 1264 dB or less) for implementing mMTC, or U-plane latency (e.g., 0.5 ms or less for each of downlink (DL) and uplink (UL), or a round trip of 12 ms or less) for implementing URLLC.

The antenna module 1297 may transmit or receive a signal or power to or from the outside (e.g., the external electronic device) of the electronic device 1201. According to an embodiment, the antenna module 1297 may include an antenna including a radiating element including a conductive material or a conductive pattern formed in or on a substrate (e.g., a printed circuit board (PCB)). According to an embodiment, the antenna module 1297 may include a plurality of antennas (e.g., array antennas). In such a case, at least one antenna appropriate for a communication scheme used in the communication network, such as the first network 1298 or the second network 1299, may be selected, for example, by the communication module 1290 (e.g., the wireless communication module 1292) from the plurality of antennas. The signal or the power may then be transmitted or received between the communication module 1290 and the external electronic device via the selected at least one antenna. According to an embodiment, another component (e.g., a radio frequency integrated circuit (RFIC)) other than the radiating element may be additionally formed as part of the antenna module 1297.

According to various embodiments, the antenna module 1297 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1201 and the external electronic device 1204 via the server 1208 coupled with the second network 1299. Each of the electronic devices 1202 or 1204 may be a device of a same type as, or a different type, from the electronic device 1201. According to an embodiment, all or some of operations to be executed at the electronic device 1201 may be executed at one or more of the external electronic devices 1202, 1204, or 1208. For example, if the electronic device 1201 should perform a function or a service automatically, or in response to a request from a user or another device, the electronic device 1201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1201. The electronic device 1201 may provide the outcome, with or without further processing of the outcome, as at least part of a reply to the request. To that end, a cloud computing, distributed computing, mobile edge computing (MEC), or client-server computing technology may be used, for example. The electronic device 1201 may provide ultra low-latency services using, e.g., distributed computing or mobile edge computing. In another embodiment, the external electronic device 1204 may include an internet-of-things (IoT) device. The server 1208 may be an intelligent server using machine learning and/or a neural network. According to an embodiment, the external electronic device 1204 or the server 1208 may be included in the second network 1299. The electronic device 1201 may be applied to intelligent services (e.g., smart home, smart city, smart car, or healthcare) based on 5G communication technology or IoT-related technology.

As described above, according to an example embodiment, an electronic device may comprise a power amplifier (PA), a first switch, a second switch, a plurality of antennas including a first antenna and a second antenna, first circuitry coupled with the first antenna, second circuitry capable of being coupled with the second antenna according to control of the second switch, a radio frequency integrated circuit (RFIC), and at least one processor comprising processing circuitry. According to an embodiment, at least one processor may be configured to, while the PA is connected to the first circuitry among the first circuitry and the second circuitry in accordance with control of the first switch, obtain, through the RFIC from the first circuitry, a first coupling signal of a sounding reference signal (SRS) transmitted with a transmit (Tx) power obtained using the PA via the first antenna. According to an embodiment, at least one processor 210 may be configured to, while the PA is connected to the second circuitry among the first circuitry and the second circuitry in accordance with control of the first switch, obtain, through the RFIC from the second circuitry coupled with the second antenna in accordance with control of the second switch, a second coupling signal of the SRS transmitted with the Tx power via the second antenna.

According to an example embodiment, the first coupling signal and the second coupling signal may be usable for a signal to be transmitted via the first antenna using the PA connected to the first circuitry from among the first circuitry and the second circuitry in accordance with control of the first switch, based on the SRS being respectively transmitted via the first antenna and the second antenna.

According to an example embodiment, the first coupling signal and the second coupling signal may be usable for determining a Tx power of the signal obtained using the PA connected to the first circuitry in accordance with control of the first switch.

According to an example embodiment, the electronic device may comprise a third switch. According to an example embodiment, at least one processor may be configured to obtain the first coupling signal, based on controlling the third switch to connect, to the RFIC, the first circuitry among the first circuitry and the second circuitry. According to an example embodiment, at least one processor may be configured to obtain the second coupling signal, based on controlling the third switch to connect, to the RFIC, the second circuitry among the first circuitry and the second circuitry.

According to an example embodiment, the first switch may comprise a first terminal connected to the PA to transmit the SRS via the first antenna, a second terminal connected to the first circuitry, a third terminal connected to the second circuitry. According to an embodiment, at least one processor may be configured to connect the PA to the first circuitry in accordance with controlling the first switch to connect the first terminal to the second terminal among the second terminal and the third terminal. According to an example embodiment, at least one processor may be configured to connect the PA to the second circuitry in accordance with controlling the first switch to connect the first terminal to the third terminal among the second terminal and the third terminal.

According to an example embodiment, the third switch may comprise a first terminal connected to the RFIC, a second terminal connected to the first circuitry, a third terminal connected to the second circuitry. According to an embodiment, at least one processor may be configured to control the third switch to connect the first terminal of the third switch to the second terminal of the third switch among the second terminal of the third switch and the third terminal of the third switch in order to obtain the first coupling signal of the SRS transmitted via the first antenna. According to an example embodiment, at least one processor may be configured to control the third switch to connect the first terminal of the third switch to the third terminal of the third switch among the second terminal of the third switch and the third terminal of the third switch in order to obtain the second coupling signal of the SRS transmitted via the second antenna.

According to an example embodiment, the second circuitry may comprise an impedance matching circuit including a first terminal and a second terminal, the first terminal of the impedance matching circuit connected to the third terminal of the first switch and connected to the second antenna based on transmitting the SRS via the second antenna and an attenuator comprising circuitry and including a first terminal connected to the second terminal of the impedance matching circuit and a second terminal connected to the third terminal of the third switch.

According to an example embodiment, the second circuitry may comprise a signal divider including a first terminal connected to the third terminal of the first switch, a second terminal connected to the second antenna based on transmitting the SRS via the second antenna, and a third terminal, and an attenuator including a first terminal connected to the third terminal of the signal divider and a second terminal connected to the third terminal of the third switch.

According to an example embodiment, the plurality of antennas may comprise a third antenna and a fourth antenna. According to an embodiment, at least one processor may be configured to, while the PA is connected to the second circuitry among the first circuitry and the second circuitry in accordance with the control of the first switch, obtain, through the RFIC from the second circuitry coupled with the second antenna among the second antenna, the third antenna, and the fourth antenna in accordance with the control of the second switch, the second coupling signal. According to an example embodiment, at least one processor may be configured to, while the PA is connected to the second circuitry among the first circuitry and the second circuitry in accordance with the control of the first switch, obtain, through the RFIC from the second circuitry coupled with the third antenna among the second antenna, the third antenna, and the fourth antenna in accordance with control of the second switch, a third coupling signal of the SRS transmitted with the Tx power via the third antenna. According to an example embodiment, at least one processor may be configured to, while the PA is connected to the second circuitry among the first circuitry and the second circuitry in accordance with the control of the first switch, obtain, through the RFIC from the second circuitry coupled with the fourth antenna among the second antenna, the third antenna, and the fourth antenna in accordance with control of the second switch, a fourth coupling signal of the SRS transmitted with the Tx power via the fourth antenna.

According to an example embodiment, the second switch may comprise a first terminal connected to the second circuitry, a second terminal connected to the second antenna, a third terminal connected to the third antenna, and a fourth terminal connected to the fourth antenna. According to an example embodiment, at least one processor may be configured to couple the second circuitry with the second antenna among the second antenna, the third antenna, and the fourth antenna in accordance with controlling the second switch to connect, to the first terminal, the second terminal among the second terminal, the third terminal, and the fourth terminal. According to an example embodiment, at least one processor may be configured to couple the second circuitry with the third antenna among the second antenna, the third antenna, and the fourth antenna in accordance with controlling the second switch to connect, to the first terminal, the third terminal among the second terminal, the third terminal, and the fourth terminal. According to an example embodiment, at least one processor may be configured to couple the second circuitry with the fourth antenna among the second antenna, the third antenna, and the fourth antenna in accordance with controlling the second switch to connect, to the first terminal, the fourth terminal among the second terminal, the third terminal, and the fourth terminal.

According to an example embodiment, the electronic device may comprise a low noise amplifier (LNA) and a third switch comprising a first terminal connected to the PA, a second terminal connected to the LNA, and a third terminal connected to the first antenna. According to an example embodiment, the first switch may comprise a first terminal of the first switch connected to the third terminal of the third switch, a second terminal of the first switch connected to the first circuitry, a third terminal of the first switch connected to the second circuitry. According to an example embodiment, at least one processor may be configured to transmit, based on controlling the third switch to connect the third terminal of the third switch to the first terminal of the third switch among the first terminal of the third switch and the second terminal of the third switch, the SRS via each of the first antenna and the second antenna.

According to an example embodiment, the electronic device may comprise a low noise amplifier (LNA) and a third switch comprising a first terminal connected to the second switch, a second terminal connected to the LNA, and a third terminal connected to the second antenna. According to an example embodiment, at least one processor may be configured to transmit the SRS via the second antenna, based on controlling the third switch to connect the third terminal to the first terminal among the first terminal and the second terminal.

According to an example embodiment, at least one processor may be configured to receive a signal via the second antenna from an external electronic device, based on controlling the third switch to connect the third terminal to the second terminal among the first terminal and the second terminal.

According to an example embodiment, the electronic device may comprise a low noise amplifier (LNA) and a third switch comprising a first terminal connected to the second circuitry, a second terminal connected to the LNA, and a third terminal connectable to the second antenna through the second switch. According to an example embodiment, at least one processor may be configured to transmit the SRS via the second antenna, based on controlling the third switch to connect the third terminal to the first terminal among the first terminal and the second terminal.

According to an example embodiment, at least one processor may be configured to receive a signal via the second antenna from an external electronic device, based on controlling the third switch to connect the third terminal to the second terminal among the first terminal and the second terminal.

As described above, according to an example embodiment, an electronic device may comprise a power amplifier (PA), a plurality of antennas including a first antenna and a second antenna, a circuit coupled with the first antenna, a first switch including a first terminal connectable to the PA, a second terminal, and a third terminal, a second switch configured to connect the second antenna to the third terminal of the first switch, a third switch including a first terminal connected to the second terminal of the first switch, a second terminal connected to the third terminal of the first switch 211 and connected to the second switch, and a third terminal connected to the circuit, a radio frequency integrated circuit (RFIC), and at least one processor comprising processing circuitry. According to an example embodiment, at least one processor may be configured to obtain, based on controlling the first switch and the third switch to connect, to the first terminal of the first switch connected to the PA, the second terminal of the first switch among the second terminal of the first switch and the third terminal of the first switch and connect, to the third terminal of the third switch, the first terminal of the third switch among the first terminal of the third switch and the second terminal of the third switch, a first coupling signal of a sounding reference signal (SRS) transmitted with a transmit (Tx) power obtained using the PA via the first antenna. According to an example embodiment, at least one processor may be configured to transmit, based on controlling the first switch to connect, to the first terminal of the first switch connected to the PA, the third terminal of the first switch among the second terminal of the first switch and the third terminal of the first switch, the SRS with Tx power via the second antenna. According to an example embodiment, at least one processor may be configured to obtain, based on controlling the third switch to connect, to the third terminal of the third switch, the second terminal of the third switch among the first terminal of the third switch and the second terminal of the third switch, a second coupling signal of the SRS transmitted via the second antenna, from the circuit through the RFIC.

According to an example embodiment, the electronic device may comprise an impedance matching circuit. According to an example embodiment, the second terminal of the third switch may be connected to the second switch through the impedance matching circuit and connected to the third terminal of the first switch through the impedance matching circuit.

According to an example embodiment, the electronic device may comprise a signal divider comprising a first terminal connected to the third terminal of the first switch, a second terminal connected to the second switch, and a third terminal connected to the second terminal of the third switch.

According to an example embodiment, the first coupling signal and the second coupling signal may be usable for a signal to be transmitted via the first antenna using the PA connected to the circuit in accordance with control of the first switch, based on the SRS respectively transmitted via the first antenna and the second antenna.

As described above, according to an example embodiment, an electronic device may comprise a power amplifier (PA), a plurality of antennas including a first antenna, a second antenna, a third antenna, and a fourth antenna, a circuit coupled with the first antenna, a radio frequency integrated circuit (RFIC), a first switch including a first terminal connectable to the PA, a second terminal connected to the circuit, and a third terminal, a second switch including a first terminal connected to the third terminal of the first switch, a second terminal connected to the second antenna, a third terminal connected to the third antenna, a fourth terminal connected to the fourth antenna, and a fifth terminal disconnected from all of the plurality of antennas, a third switch including a first terminal connected to the RFIC, a second terminal connected to the circuit, and a third terminal connected to the fifth terminal of the second switch, and at least one processor comprising processing circuitry. According to an example embodiment, at least one processor may be configured to obtain a first coupling signal of a sounding reference signal (SRS) transmitted with a transmit (Tx) power obtained using the PA via the first antenna, through the RFIC from the circuit, based on controlling the first switch and the third switch to connect, to the second terminal of the first switch among the second terminal of the first switch and the third terminal of the first switch, the first terminal of the first switch connected to the PA and connect, to the second terminal of the third switch among the second terminal of the third switch and the third terminal of the third switch, the first terminal of the third switch. According to an example embodiment, at least one processor may be configured to transmit the SRS with the Tx power via each of the second antenna, the third antenna, and the fourth antenna, based on controlling the first switch to connect the third terminal of the first switch among the second terminal of the first switch and the third terminal of the first switch to the first terminal of the first switch connected to the PA. According to an example embodiment, at least one processor may be configured to obtain each of a second coupling signal, a third coupling signal, a fourth coupling signal of the SRS transmitted via each of the second antenna, the third antenna, and the fourth antenna, through the RFIC from the circuit, based on controlling the third switch to connect the third terminal of the third switch among the second terminal of the third switch and the third terminal of the third switch to the first terminal of the third switch.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and docs not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1240) including one or more instructions that are stored in a storage medium (e.g., internal memory 1236 or external memory 1238) that is readable by a machine (e.g., the electronic device 1201). For example, a processor (e.g., the processor 1220) of the machine (e.g., the electronic device 1201) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a power amplifier (PA);
a first switch;
a second switch;
a plurality of antennas including a first antenna and a second antenna;
first circuitry coupled with the first antenna;
second circuitry capable of being coupled with the second antenna according to control of the second switch;
a radio frequency integrated circuit (RFIC); and
at least one processor, comprising processing circuitry; and
a memory storing instructions to, when executed by the at least one processor, cause the electronic device to:
while the PA is connected to the first circuitry among the first circuitry and the second circuitry in accordance with control of the first switch, obtain, through the RFIC from the first circuitry, a first coupling signal of a sounding reference signal (SRS) transmitted with a transmit (Tx) power obtained using the PA via the first antenna; and
while the PA is connected to the second circuitry among the first circuitry and the second circuitry in accordance with control of the first switch, obtain, through the RFIC from the second circuitry coupled with the second antenna in accordance with control of the second switch, a second coupling signal of the SRS transmitted with the Tx power via the second antenna.

2. The electronic device of claim 1, wherein the first coupling signal and the second coupling signal are usable for a signal to be transmitted via the first antenna using the PA connected to the first circuitry among the first circuitry and the second circuitry in accordance with control of the first switch, based on the SRS being respectively transmitted via the first antenna and the second antenna.

3. The electronic device of claim 2, wherein the first coupling signal and the second coupling signal are usable for determining a Tx power of the signal obtained using the PA connected to the first circuitry in accordance with control of the first switch.

4. The electronic device of claim 1, further comprising:
a third switch,
wherein the instructions, when executed by the at least one processor, cause the electronic device to:
obtain the first coupling signal, based on controlling the third switch to connect, to the RFIC, the first circuitry among the first circuitry and the second circuitry; and
obtain the second coupling signal, based on controlling the third switch to connect, to the RFIC, the second circuitry among the first circuitry and the second circuitry.

5. The electronic device of claim 4, wherein the first switch comprises:
a first terminal connected to the PA to transmit the SRS via the first antenna;
a second terminal connected to the first circuitry; and
a third terminal connected to the second circuitry, and
wherein the instructions, when executed by the at least one processor, cause the electronic device to:
connect the PA to the first circuitry in accordance with controlling the first switch to connect the first terminal to the second terminal among the second terminal and the third terminal; and
connect the PA to the second circuitry in accordance with controlling the first switch to connect the first terminal to the third terminal among the second terminal and the third terminal.

6. The electronic device of claim 5, wherein the third switch comprises
a first terminal connected to the RFIC;
a second terminal connected to the first circuitry; and
a third terminal connected to the second circuitry, and
wherein the instructions, when executed by the at least one processor, cause the electronic device to:
control the third switch to connect the first terminal of the third switch to the second terminal of the third switch among the second terminal of the third switch and the third terminal of the third switch to obtain the first coupling signal of the SRS transmitted via the first antenna; and
control the third switch to connect the first terminal of the third switch to the third terminal of the third switch among the second terminal of the third switch and the third terminal of the third switch to obtain the second coupling signal of the SRS transmitted via the second antenna.

7. The electronic device of claim 6, wherein the second circuitry comprises:
an impedance matching circuit including a first terminal and a second terminal, the first terminal of the impedance matching circuit connected to the third terminal of the first switch and connected to the second antenna based on transmitting the SRS via the second antenna; and
an attenuator including a first terminal connected to the second terminal of the impedance matching circuit and a second terminal connected to the third terminal of the third switch.

8. The electronic device of claim 6, wherein the second circuitry comprises:
a signal divider including a first terminal, a second terminal, and a third terminal, wherein the first terminal of the signal divider is connected to the third terminal of the first switch, and wherein the second terminal of the signal divider is connected to the second antenna based on transmitting the SRS via the second antenna; and
an attenuator including a first terminal connected to the third terminal of the signal divider and a second terminal connected to the third terminal of the third switch.

9. The electronic device of claim 1, wherein the plurality of antennas further comprises:
a third antenna; and
a fourth antenna, and
wherein the instructions, when executed by the at least one processor, cause the electronic device to:
while the PA is connected to the second circuitry among the first circuitry and the second circuitry in accordance with the control of the first switch, obtain, through the RFIC from the second circuitry coupled with the second antenna among the second antenna, the third antenna, and the fourth antenna in accordance with the control of the second switch, the second coupling signal;
while the PA is connected to the second circuitry among the first circuitry and the second circuitry in accordance with the control of the first switch, obtain, through the RFIC from the second circuitry coupled with the third antenna among the second antenna, the third antenna, and the fourth antenna in accordance with control of the second switch, a third coupling signal of the SRS transmitted with the Tx power via the third antenna; and
while the PA is connected to the second circuitry among the first circuitry and the second circuitry in accordance with the control of the first switch, obtain, through the RFIC from the second circuitry coupled with the fourth antenna among the second antenna, the third antenna, and the fourth antenna in accordance with control of the second switch, a fourth coupling signal of the SRS transmitted with the Tx power via the fourth antenna.

10. The electronic device of claim 9, wherein the second switch comprises:
a first terminal connected to the second circuitry;
a second terminal connected to the second antenna;
a third terminal connected to the third antenna; and
a fourth terminal connected to the fourth antenna,
wherein the instructions, when executed by the at least one processor, cause the electronic device to:
couple the second circuitry with the second antenna among the second antenna, the third antenna, and the fourth antenna in accordance with controlling the second switch to connect, to the first terminal, the second terminal among the second terminal, the third terminal, and the fourth terminal;
couple the second circuitry with the third antenna among the second antenna, the third antenna, and the fourth antenna in accordance with controlling the second switch to connect, to the first terminal, the third terminal among the second terminal, the third terminal, and the fourth terminal; and
couple the second circuitry with the fourth antenna among the second antenna, the third antenna, and the fourth antenna in accordance with controlling the second switch to connect, to the first terminal, the fourth terminal among the second terminal, the third terminal, and the fourth terminal.

11. The electronic device of claim 1, further comprising:
a low noise amplifier (LNA); and
a third switch comprising a first terminal connected to the PA, a second terminal connected to the LNA, and a third terminal connected to the first antenna,
wherein the first switch comprises:
a first terminal of the first switch connected to the third terminal of the third switch;
a second terminal of the first switch connected to the first circuitry; and
a third terminal of the first switch connected to the second circuitry, and
wherein the instructions, when executed by the at least one processor, cause the electronic device to:
transmit, based on controlling the third switch to connect the third terminal of the third switch to the first terminal of the third switch among the first terminal of the third switch and the second terminal of the third switch, the SRS via each of the first antenna and the second antenna.

12. The electronic device of claim 1, further comprising:
a low noise amplifier (LNA); and
a third switch comprising a first terminal connected to the second switch, a second terminal connected to the LNA, and a third terminal connected to the second antenna,
wherein the instructions, when executed by the at least one processor, cause the electronic device to:
transmit the SRS via the second antenna, based on controlling the third switch to connect the third terminal to the first terminal from among the first terminal and the second terminal.

13. The electronic device of claim 12, wherein the instructions, when executed by the at least one processor, cause the electronic device to:
receive a signal via the second antenna from an external electronic device, based on controlling the third switch to connect the third terminal to the second terminal among the first terminal and the second terminal.

14. The electronic device of claim 1, further comprising:
a low noise amplifier (LNA); and
a third switch comprising a first terminal connected to the second circuitry, a second terminal connected to the LNA, and a third terminal connectable to the second antenna through the second switch,
wherein the instructions, when executed by the at least one processor, cause the electronic device to:
transmit the SRS via the second antenna, based on controlling the third switch to connect the third terminal to the first terminal among the first terminal and the second terminal.

15. The electronic device of claim 14, wherein the instructions, when executed by the at least one processor, cause the electronic device to:
receive a signal via the second antenna from an external electronic device, based on controlling the third switch to connect the third terminal to the second terminal among the first terminal and the second terminal.

16. An electronic device comprising:
a power amplifier (PA);
a plurality of antennas including a first antenna and a second antenna;
a circuit coupled with the first antenna;
a first switch including a first terminal connectable to the PA, a second terminal, and a third terminal;
a second switch configured to connect the second antenna to the third terminal of the first switch;
a third switch including a first terminal connected to the second terminal of the first switch, a second terminal connected to the third terminal of the first switch and connected to the second switch, and a third terminal connected to the circuit;
a radio frequency integrated circuit (RFIC);
at least one processor, comprising processing circuitry; and
a memory storing instructions to, when executed by the at least one processor, cause the electronic device to:
obtain, based on controlling the first switch and the third switch to connect, to the first terminal of the first switch connected to the PA, the second terminal of the first switch among the second terminal of the first switch and the third terminal of the first switch and connect, to the third terminal of the third switch, the first terminal of the third switch among the first terminal of the third switch and the second terminal of the third switch, a first coupling signal of a sounding reference signal (SRS) transmitted with a transmit (Tx) power obtained using the PA via the first antenna;
transmit, based on controlling the first switch to connect, to the first terminal of the first switch connected to the PA, the third terminal of the first switch among the second terminal of the first switch and the third terminal of the first switch, the SRS with Tx power via the second antenna; and
obtain, based on controlling the third switch to connect, to the third terminal of the third switch, the second terminal of the third switch among the first terminal of the third switch and the second terminal of the third switch, a second coupling signal of the SRS transmitted via the second antenna, from the circuit through the RFIC.

17. The electronic device of claim 16, further comprising:
an impedance matching circuit,
wherein the second terminal of the third switch is connected to the second switch through the impedance matching circuit and is connected to the third terminal of the first switch through the impedance matching circuit.

18. The electronic device of claim 16, further comprising:
a signal divider comprising a first terminal connected to the third terminal of the first switch, a second terminal connected to the second switch, and a third terminal connected to the second terminal of the third switch.

19. The electronic device of claim 16, wherein the first coupling signal and the second coupling signal are usable for a signal to be transmitted via the first antenna using the PA connected to the circuit in accordance with control of the first switch, based on the SRS being respectively transmitted via the first antenna and the second antenna.

20. An electronic device comprising:
a power amplifier (PA);
a plurality of antennas including a first antenna, a second antenna, a third antenna, and a fourth antenna;
a circuit coupled with the first antenna;
a radio frequency integrated circuit (RFIC);
a first switch including a first terminal connectable to the PA, a second terminal connected to the circuit, and a third terminal;
a second switch including a first terminal connected to the third terminal of the first switch, a second terminal connected to the second antenna, a third terminal connected to the third antenna, a fourth terminal connected to the fourth antenna, and a fifth terminal disconnected from all of the plurality of antennas;
a third switch including a first terminal connected to the RFIC, a second terminal connected to the circuit, and a third terminal connected to the fifth terminal of the second switch;
at least one processor, comprising processing circuitry; and
a memory storing instructions to, when executed by the at least one processor, cause the electronic device to:
based on controlling the first switch and the third switch to connect, to the second terminal of the first switch among the second terminal of the first switch and the third terminal of the first switch, the first terminal of the first switch connected to the PA and connect, to the second terminal of the third switch among the second terminal of the third switch and the third terminal of the third switch, the first terminal of the third switch, obtain a first coupling signal of a sounding reference signal (SRS) transmitted with a transmit (Tx) power obtained using the PA via the first antenna, through the RFIC from the circuit;
based on controlling the first switch to connect the third terminal of the first switch among the second terminal of the first switch and the third terminal of the first switch to the first terminal of the first switch connected to the PA, transmit the SRS with the Tx power via each of the second antenna, the third antenna, and the fourth antenna; and
based on controlling the third switch to connect the third terminal of the third switch among the second terminal of the third switch and the third terminal of the third switch to the first terminal of the third switch, obtain each of a second coupling signal, a third coupling signal, a fourth coupling signal of the SRS transmitted via each of the second antenna, the third antenna, and the fourth antenna, through the RFIC from the circuit.
